(19) United States
(12) Patent Application Publication
(10) Pub. No.: US 2007/0070400 A1
(43) Pub. Date: Mar. 29, 2007

(54) Information processing apparatus, information managing apparatus, information storing method and information storing program

(75) Inventor: Yasuhiro Matsumura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/387,775

(22) Filed: Mar. 24, 2006

(30) Foreign Application Priority Data
Sep. 12, 2005 (JP) 2005-263472

(51) Int. Cl. G06F 3/12

(52) U.S. Cl. 358/1.15; 358/448

(57) ABSTRACT

In an information processing apparatus capable of communicating with an information managing apparatus capable of managing information stored in the information processing apparatus, the information processing apparatus is comprised of: storage means for storing thereinto identification information which identifies predetermined information from the stored information so as to call the identified information from the information managing apparatus; identification information managing means for editing the identification information stored in the storage means so as to manage the edited identification information; and information transmitting/receiving means for instructing an acquisition of the stored information in order that information managed in the identification information managing means is transmitted to the information managing apparatus, and for transmitting/receiving the identification information and the stored information with respect to the information managing apparatus.

### BACKGROUND OF THE INVENTION

1. Field of the Invention

The present invention is related to technical ideas capable of suppressing memory storage capacities used for telephone directories and the like of portable communication apparatus, and also capable of preventing leakage of stored information due to the lost of the portable communication apparatus.

2. Description of the Related Art

Presently, various sorts of information have been continuously stored in portable communication apparatus. While a large amount of the information is stored in these portable communication apparatus, various sorts of functions are accompanied. As a result, there is a risk of a shortage of memory storage capacities.

On the other hand, in the case that these portable communication apparatus are lost, and then, are accidentally transferred to persons who own ill wills, there are some possibilities that these persons abuse information stored in these memories.

As conventional information processing apparatus capable of solving the above-described problems, one technical idea has been proposed in Japanese Patent Application Laid-Open No. 2002-94672. That is, in this opened patent application, the user uploads the telephone numbers stored in the telephone directory of the portable telephone to the personal telephone directory of the server, and in response to the instruction issued from the user, the server downloads the telephone numbers stored in the personal telephone directory to the portable telephone.

Furthermore, another technical idea has been proposed in Japanese Patent Application Laid-Open No. 2002-335334. That is, in this opened patent application, the telephone directory data which will be stored in the telephone apparatus may be easily backup-processed, and further, the telephone directory data which has been backup-processed may be readily acquired even where the user has gone.

However, in these conventional technical ideas, the owners of the portable communication apparatus download the data from the information managing servers if required. As a result, although these data are held under backup condition, certain storage capacities of memories capable of downloading/storing these backup data must be secured in these conventional portable communication apparatus.

Also, when the conventional portable communication apparatus are lost, normally, various sorts of information have been stored in these portable communication apparatus. In such a case that these conventional portable communication apparatus are accidentally transferred to any persons who own ill wills, there are some possibilities that these persons abuse the stored information.

### SUMMARY OF THE INVENTION

To solve the above-described problems of the prior art, the present invention has an object to provide an information processing apparatus, an information storing method, and an information storing program. That is, for instance, while such information as a telephone directory, a mail address, and an apparatus ID (identification), which are held in a portable communication apparatus, are managed in an information managing server separately provided with the above-described portable communication apparatus, only an ID used to link the above-explained information to the portable communication apparatus and another information which is employed so as to recognize that the link ID corresponds to what information recognized by an owner of this portable communication apparatus are held in the portable communication apparatus. When the owner of the portable communication apparatus uses the portable communication apparatus, the owner transmits ID corresponding to an action such as a telephone calling operation and a mail transmission to the information managing server, and then, the information managing server commences a communicating operation by taking the initiative.

An information processing apparatus, according to an aspect of the present invention, is featured by such an information processing apparatus capable of communicating with an information managing apparatus capable of managing information stored in the information processing apparatus, comprising: storage means for storing thereinto identification information which identifies predetermined information from the stored information so as to call the identified information from the information managing apparatus; identification information managing means for editing the identification information stored in the storage means so as to manage the edited identification information; and information transmitting/receiving means for instructing an acquisition of the stored information in order that information managed in the identification information managing means is transmitted to the information managing apparatus, and for transmitting/receiving the identification information and the stored information with respect to the information managing apparatus.

Also, the information processing apparatus, according to the present invention, is featured by further comprising: transmission/reception information capacity determining means for determining as to whether or not both the identification information and the stored information, which are transmitted/received by the information transmitting/receiving means, can be transmitted/received within 1 time; and information dividing means for dividing both the identification information and the stored information in the case that the transmission/reception information capacity determining means determines that both the identification information and the stored information cannot be transmitted/received within 1 time.

Also, an information managing apparatus, according to another aspect of the present invention, is featured by such an information managing apparatus capable of communicating with an information processing apparatus and capable of managing information stored in the information processing apparatus, comprising: information storage means for storing therein the stored information; information managing means for managing based upon identification information which identifies predetermined information from the stored information so as to call the identified information from the information managing apparatus; identification retrieving means capable of retrieving both the stored information and the identification information; identification information setting means for editing/setting the identification information retrieved by the information retrieving means; and information transmitting/receiving means for transmitting/receiving both the identification information and the stored information with respect to the information processing apparatus.

Also, an information storing program, according to another aspect of the present invention, is featured by that in an information storing program capable of communicating information stored in an information processing apparatus with respect to an information managing apparatus capable of managing the stored information, the information storing program causes a computer to execute: a storage step for storing identification information which identifies predetermined information from the stored information so as to call the identified information from the information managing apparatus; an identification information managing step for editing the identification information so as to manage the edited identification information; and an information transmitting/receiving step for instructing an acquisition of the stored information in order that information managed in the identification information managing step is transmitted to the information managing apparatus, and for transmitting/receiving the identification information and the stored information with respect to the information managing apparatus.

An information storing method, according to a further aspect of the present invention, is featured by such an information storing method capable of communicating information stored in an information processing apparatus with respect to an information managing apparatus capable of managing the stored information, comprising: a storage step for storing identification information which identifies predetermined information from the stored information so as to call the identified information from the information managing apparatus; an identification information managing step for editing the identification information so as to manage the edited identification information; and an information transmitting/receiving step for instructing an acquisition of the stored information in order that information managed in the identification information managing step is transmitted to the information managing apparatus, and for transmitting/receiving the identification information and the stored information with respect to the information managing apparatus.

In accordance with the present invention, as to the information stored in the portable communication apparatus, only the information identification ID and the information which is recognized by the owner are merely secured in the memory of the portable communication apparatus, so that the used storage capacity of the memory can be reduced.

Also, even when the portable communication apparatus is lost, or dropped in water, since the contents of the memory have been stored in the information managing server, if the information identification ID and the information which is recognized by the owner are again downloaded, then the same information can be handled.

Also, even in such a case that the portable communication apparatus is stolen by a person who has an ill will, since the apparatus ID of the portable communication apparatus is invalidated, leakage of the personal information can be prevented.

### BRIEF DESCRIPTION OF THE DRAWINGS

FIG. 1 is a schematic block diagram for showing an arrangement of a portable communication apparatus according to an embodiment of the present invention.

FIG. 2 is a schematic block diagram for indicating an arrangement of an information managing server according to an embodiment of the present invention.

FIG. 3 is a diagram for illustratively representing a structural example of a communication network for explaining the present invention.

FIG. 4 is a sequence diagram for acquiring server storage information in the portable communication apparatus shown in FIG. 1 of the embodiment.

FIG. 5 is a sequence diagram for setting new information to the server storage information in the portable communication apparatus of the embodiment.

FIG. 6 is a sequence diagram for displaying information of the server storage information in the portable communication apparatus of the embodiment.

FIG. 7 is a sequence diagram for changing information of the server storage information in the portable communication apparatus of the embodiment.

FIG. 8 is a sequence diagram for deleting the server storage information in the portable communication apparatus of the embodiment.

FIG. 9 is a sequence diagram for acquiring the server storage information in a batch mode in the portable communication apparatus of the embodiment.

FIG. 10 is a sequence diagram for setting the server storage information in a batch mode in the portable communication apparatus of the embodiment.

FIG. 11 is a sequence diagram for explaining a call connection processing operation executed in the portable communication apparatus.

FIG. 12 is a sequence diagram for explaining another call connection processing operation executed in the portable communication apparatus.

FIG. 13 is a sequence diagram for explaining a received call connection processing operation executed in the portable communication apparatus.

FIG. 14 is a sequence diagram for explaining a mail transmission processing operation executed in the portable communication apparatus.

FIG. 15 is a sequence diagram for explaining a mail reception processing operation executed in the portable communication apparatus.

FIG. 16 is a sequence diagram for requesting to acquire information from the portable communication apparatus performed in the information managing server shown in FIG. 2.

FIG. 17 is a sequence diagram for requesting to set new information from the portable communication apparatus performed in the information managing server.

FIG. 18 is a sequence diagram for requesting to acquire detailed information from the portable communication apparatus performed in the information managing server.

FIG. 19 is a sequence diagram for requesting to set new information from the portable communication apparatus performed in the information managing server.

FIG. 20 is a sequence diagram for requesting to delete information from the portable communication apparatus performed in the information managing server.

FIG. 21 is a sequence diagram for requesting to acquire information in a batch mode from the portable communication apparatus performed in the information managing server.

FIG. 22 is a sequence diagram for requesting to set information in a batch mode from the portable communication apparatus performed in the information managing server.

FIG. 23 is a sequence diagram for explaining a call connection processing operation executed in the information managing server.

FIG. 24 is a sequence diagram for explaining another call connection processing operation executed in the information managing server.

FIG. 25 is a sequence diagram for explaining a received call connection processing operation executed in the information managing server.

FIG. 26 is a sequence diagram for explaining a mail transmission processing operation executed in the information managing server.

FIG. 27 is a sequence diagram for explaining a mail reception processing operation executed in the information managing server.

### DESCRIPTION OF THE PREFERRED EMBODIMENTS

Referring now to drawings, various embodiments of the present invention will be described.

In these embodiments, a portable communication apparatus 100 corresponds to, concretely speaking, an information processing apparatus such as a portable telephone and a PDA (Personal Digital Assistance).

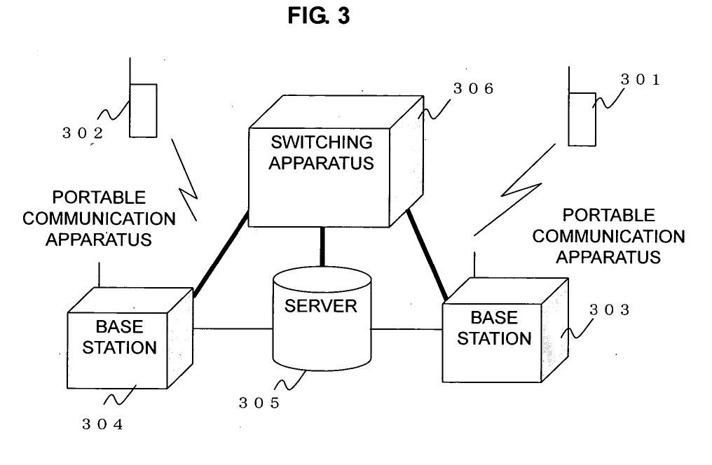

It should be understood that bold lines and bold arrow symbols indicated in FIG. 3 and succeeding drawings represent transmissions/receptions of notification between the portable communication apparatus 100 and another apparatus such as a switching unit of a transmission path system.

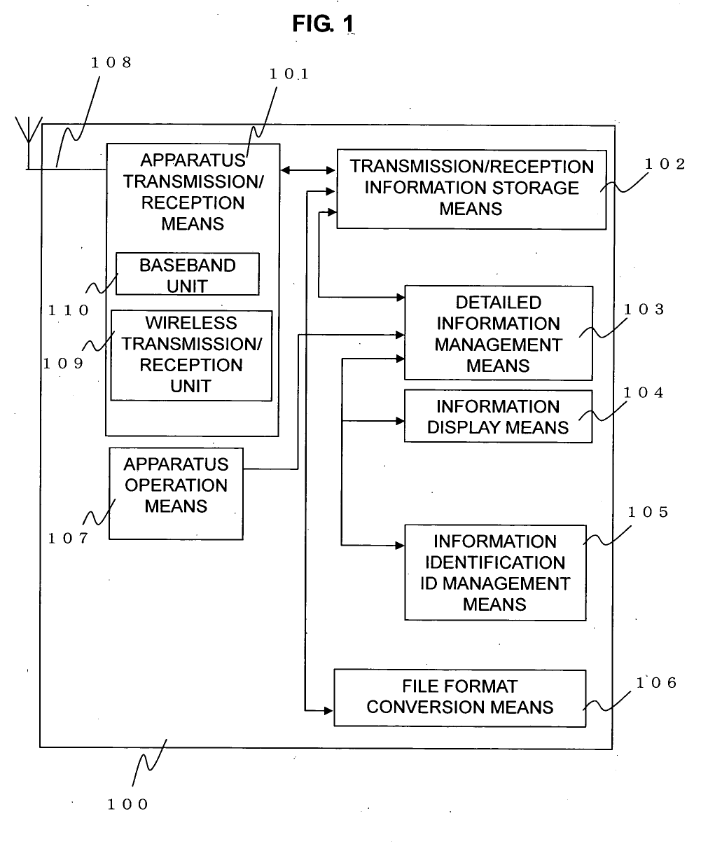

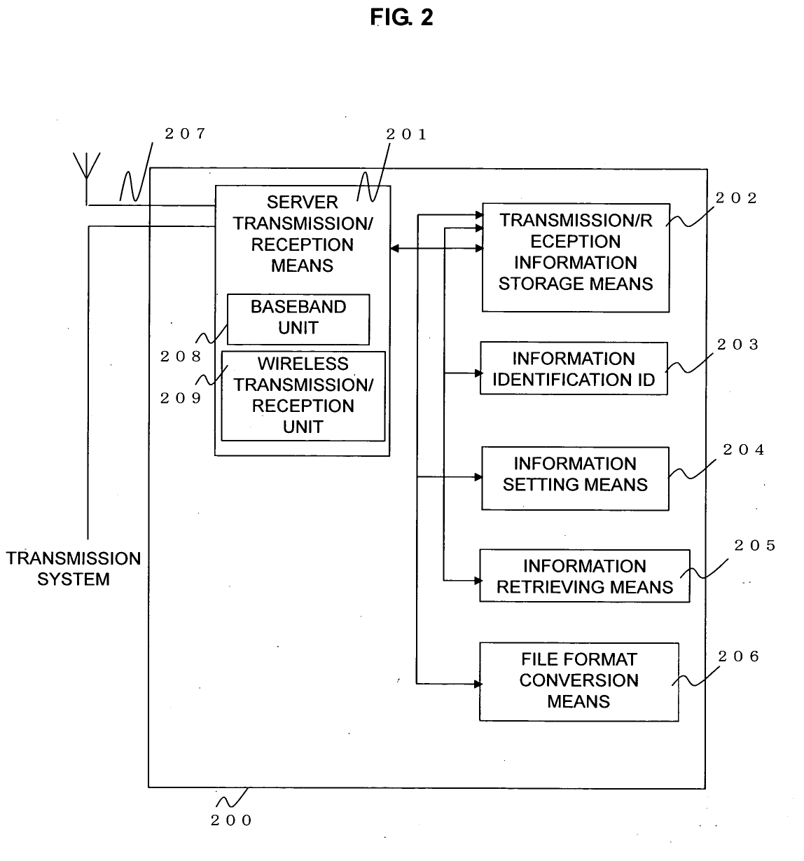

FIG. 1 is a schematic block diagram for showing an arrangement of a portable communication apparatus according to an embodiment of the present invention. FIG. 2 is a schematic block diagram for indicating an arrangement of an information managing server according to an embodiment of the present invention. FIG. 3 is a diagram for illustratively representing a structural example of a communication network for explaining the present invention.

The information managing server will be referred to as a “server” hereinafter in the below-mentioned descriptions.

The portable communication apparatus 100 of FIG. 1 is arranged by an apparatus transmission/reception means 101, a transmission/reception information storage means 102, a detailed information management means 103, an information display means 104, an information identification ID management means 105, a file format conversion means 106, and an apparatus operation means 107. The apparatus operation means 107 controls and operates the transmission/reception information storage means 102, the detailed information management means 103, the information display means 104, the information identification ID management means 105, and the file format conversion means 106. The apparatus transmission/reception means 101 performs a wireless communication between the server and the switching apparatus of the transmission system. The transmission/reception information storage means 102 stores thereinto information during a transmission operation and a reception operation. The detailed information management information 103 manages information when detailed information is handled. The information display means 104 displays thereon information so as to notify the information to an owner. The information identification ID management means 105 manages both information identification ID and information which is used to be recognized by the owner. The file format conversion means 106 controls all data in a file format.

The apparatus transmission/reception means 101 contains a wireless transmission/reception unit 109 and a baseband unit 110. The baseband unit 110 modulates and demodulates a carrier signal by a telephone communication signal, a dialing signal, and so on. The wireless transmission/reception unit 110 transmits and/or receives a wireless signal via an antenna 108 to/from a base station and a network, and stores provided transmission/reception information into the transmission/reception information storage means 102.

The transmission/reception information storage means 102 constitutes a storage unit which stores thereinto the transmission/reception information. In the transmission/reception information storage means 102, information related to the portable communication apparatus 100 has been stored which is transmitted, or received in the apparatus transmission/reception means 101. The above-explained transmission/reception information is read out by the apparatus operation means 107, and also, new information provided by the base station and the network is stored in the transmission/reception information storage means 102.

Then, the transmission/reception information storage means 102 indicates a ROM (Read-Only Memory), a RAM (Random Access Memory), and the like in a generalization manner. The transmission/reception information storage means 102 may be constituted by employing a detachable recording medium, or may be alternatively constructed as a memory whose stored content is not erased even when a supply of electric power is released, for example, a flash memory, and the like.

The detailed information management means 103 manages detailed information under control of the apparatus operation means 107.

The information display means 104 is arranged by, for example, an LCD (Liquid Crystal Display). Information such as characters, figures, and photographic images is displayed on the information display means 104. Although not shown in the drawings, as an information input unit, a key input unit is provided, and a microphone and a speaker are provided in order to input/output information under control of the apparatus operation means 107. The key input unit is employed so as to input information, whereas the microphone is employed so as to acquire a voice signal with respect to the apparatus operation means 107. Also, the speaker is employed in order to reproduce a voice signal outputted from the apparatus operation means 107, and also, reproduce a voice signal acquired via the microphone.

The file format conversion means 106 corresponds to such a means for converting all data into data in a file format, for example, converting all data into data in a text format.

The apparatus operation means 107 is constituted by employing a computer equipped with a CPU (Central processing Unit), a ROM, a RAM, and the like. The apparatus operation means 107 performs various sorts of control operations, namely, a detailed information management control operation, an information display control operation, an information identification ID control operation, and a file format conversion control operation by employing the transmission/reception information storage means 102, the detailed information management means 103, the information display means 104, the information ID means 105, the file format converting means 106, and the like.

These control operations are processed by executing a control program stored in the ROM contained by the apparatus operation means 107. It should also be understood that the place where the control program has been stored is not limited only to the ROM, but may be alternatively realized by another recording medium which is equivalent to the ROM.

It should also be understood that the arrangement related to a predetermined function such as the conventional function to the switching apparatus of the transmission path in the portable communication apparatus 100 is not indicated, and explanations thereof are omitted.

In FIG. 2, the server 200 is arranged by a server transmission/reception means 201, an information identification ID management means 203, an information setting means 204, an information retrieving means 205, and a file format conversion means 206. The server transmission/reception means 201 performs a wireless communication with respect to the portable communication apparatus 100, and also, performs a wired communication with respect to the switching apparatus of the transmission path system. The transmission/reception information storage means 202 stores thereinto information during a transmission operation and a reception operation. The information identification ID management means 205 manages a relationship between information identification ID and detailed information. The information setting means 204 stores thereinto information. The information retrieving means 205 retrieves the information which has been stored. The file formation conversion means 206 controls all data in a file format.

The server transmission/reception means 201 contains a wireless transmission/reception unit 209 and a baseband unit 208. The baseband unit 208 modulates and demodulates a carrier signal by a telephone communication signal, a dialing signal, and so on. The wireless transmission/reception unit 209 transmits and/or receives a wireless signal via an antenna 207 to/from a base station and a network, and stores provided transmission/reception information into the transmission/reception information storage means 202.

The transmission/reception information storage means 202 constitutes a storage unit which stores thereinto the transmission/reception information. In the transmission/reception information storage means 202, such an information related to the portable communication apparatus 100 has been stored which is transmitted, or received by the server transmission/reception means 201. The above-explained transmission/reception information is read out by the information setting means 204, and also, new information provided by the base station and the network is stored in the transmission/reception information storage means 202.

Then, the transmission/reception information storage means 202 indicates a ROM (Read-Only Memory), a RAM (Random Access Memory), and the like in a generalization manner. The transmission/reception information storage means 202 may be constituted by employing a detachable recording medium, or may be alternatively constructed as a memory whose storage content is not erased even when a supply of electric power is released, for example, a flash memory, and the like.

The information identification ID management means 203 manages the relationship between the information identification ID and the detailed information under control of the information setting means 204.

The information retrieving means 205 retrieves the information which has been stored in the transmission/reception information storage means 202. In this embodiment, information to be retrieved corresponds to, for example, information which is transmitted to the portable communication apparatus 100, information whose content is changed, and information which is deleted in response to a request of the portable communication apparatus 100.

The file format conversion means 206 corresponds to such a means for converting all data into data in a file format, for example, converting all data into data in text format.

The information setting means 204 is constituted by employing a computer equipped with a CPU (Central Processing Unit), a ROM, a RAM, and the like. The information setting means 204 performs various sorts of control operations, namely, a transmission/reception information storage control operations, and a file format conversion control operation.

These control operations are processed by executing a control program stored in the ROM contained by the information setting means 204. It should also be understood that the place where the control program has been stored is not limited only to the ROM, but may be alternatively realized by another recording medium which is equivalent to the ROM.

It should also be understood that for the sake of an easy explanation, other apparatus such as the switching apparatus of the transmission path system, which has no direct relationship with the present invention are not shown, for example, the arrangement related to a predetermined function such as the conventional function, e.g., a mail server are not indicated, but also, explanations thereof are omitted.

In FIG. 3, the network is constructed as follows: A portable communication apparatus 301 and another portable communication apparatus 302 have been connected via a server 305 to a base station 303 and another base station 304, which are communicated with the portable communication apparatus 301 and 302 in a wireless manner. The information as to the portable communication apparatus 301 and 302 is managed by the server 305, and the information is exchanged between the portable communication apparatus 301 and 302, and the server 305.

Also, a switching apparatus 306 of a transmission path system has been connected from the portable communication apparatus 301 and 302 via the base stations 303 and 304. A path for connecting the switching apparatus 306 with the portable communication apparatus 301 and 302 is used so as to connect a telephone communication path from the portable telephone communication apparatus 301 to the portable telephone communication apparatus 302.

Also, while the server 305 has been connected to the switching apparatus 306 of the transmission path system, the switching apparatus 306 of the transmission path system is capable of accepting call connecting operations and call disconnecting operations from the server 305.

Next, information operating process operations of the portable communication apparatus 100 according to the embodiment of the present invention will now be explained with reference to sequence diagrams.

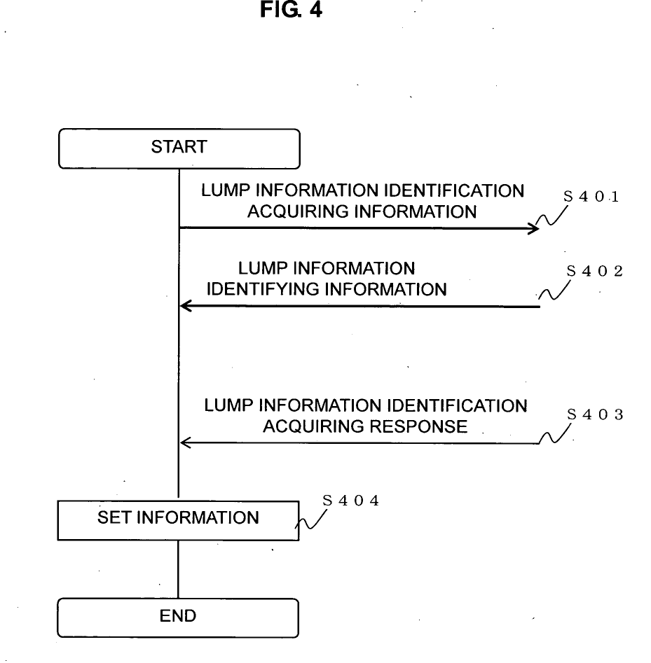

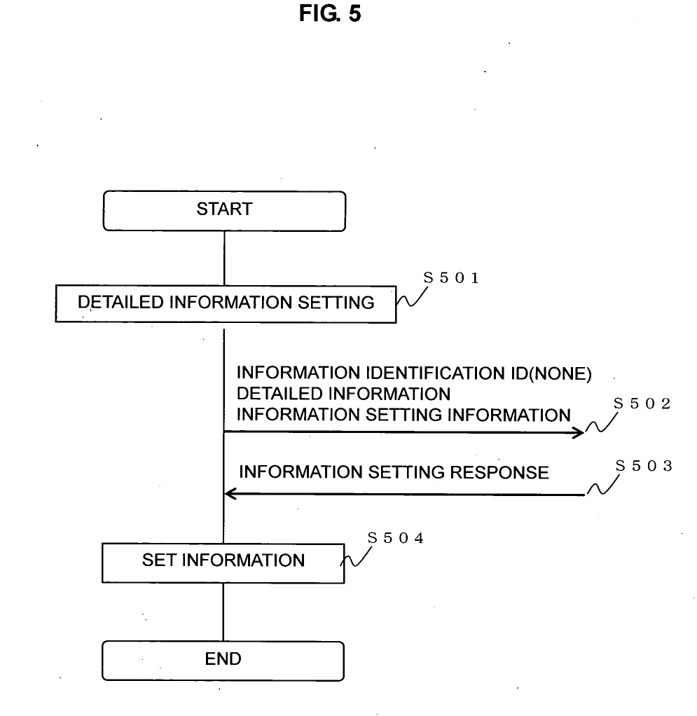

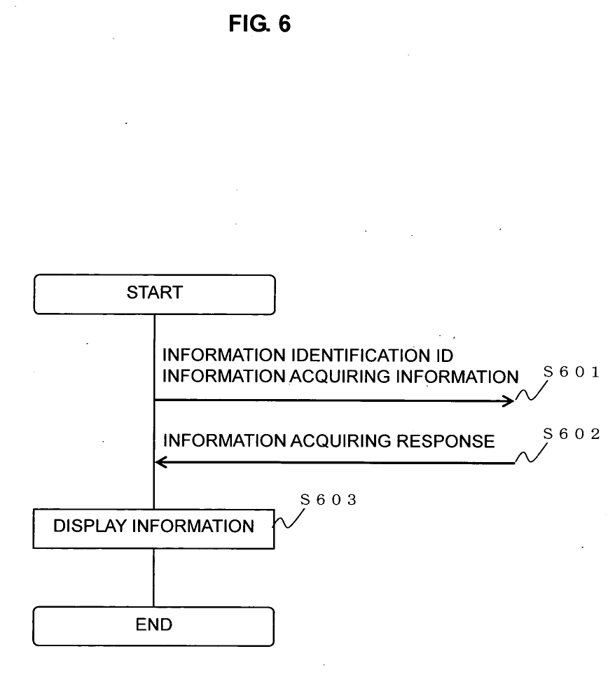

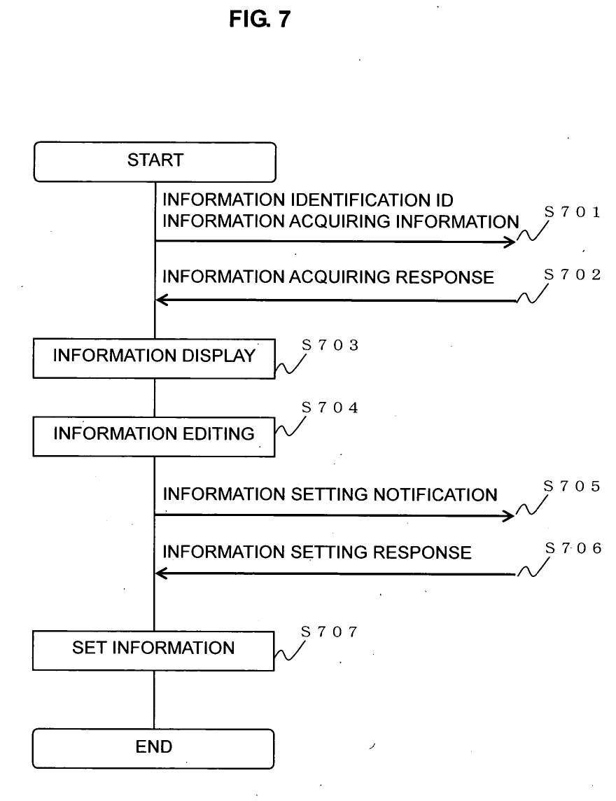

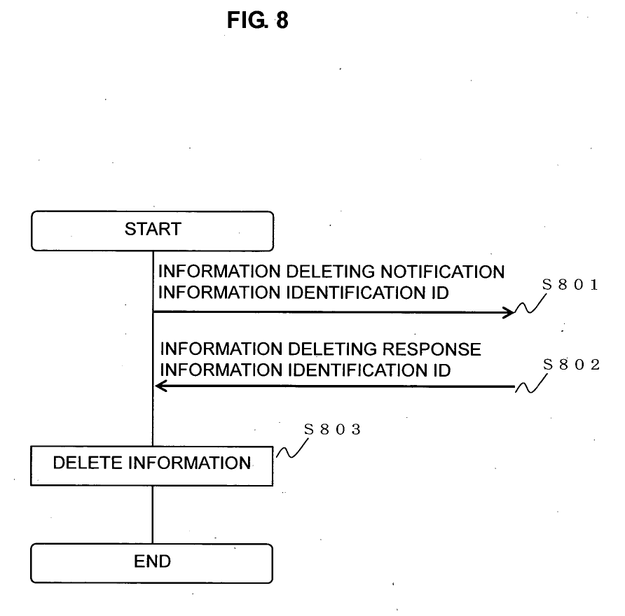

FIG. 4 is a sequence diagram for indicating process operations executed when server storage information is acquired in the portable communication apparatus 100, for example, when information identification ID and recognition information are acquired in the portable communication apparatus 100 of the embodiment shown in FIG. 1. FIG. 5 is a sequence diagram for setting new information to the server storage information in the portable communication apparatus 100 of the embodiment. FIG. 6 is a sequence diagram for displaying information of the server storage information in the portable communication apparatus 100 of the embodiment. FIG. 7 is a sequence diagram for changing information of the server storage information in the portable communication apparatus 100 of the embodiment. FIG. 8 is a sequence diagram for deleting the server storage information in the portable communication apparatus 100 of the embodiment.

In FIG. 4, first of all, the portable communication apparatus 100 notifies lump information identification acquiring information to the server 200 by employing the apparatus transmission/reception means 101 (step S401). In this case, the above-explained lump information identification acquiring information corresponds to recognition information which can be recognized by the owner of the portable communication apparatus 100, for example, implies such an information which designates individual detailed information which has been stored in the transmission/reception information storage means 102 of the portable communication apparatus 100. The individual detailed information corresponds to, for instance, names, telephone numbers, mail addresses, and the like of friends and fellow workers with respect to the owner of the portable communication apparatus 100. As to detailed information which is designated, if there are plural pieces of detailed information which have been stored in the server 200, then any one of these plural pieces of detailed information may be employed.

Then, the server 200 applies information identification ID with respect to the detailed information which is designated by the lump information acquiring information received from the portable communication apparatus 100, and notifies lump information identifying information to the portable communication apparatus 100 by employing the server transmission/reception means 201 (step S402). It should be understood that the above-explained lump information identifying information is constituted by an information identification ID and recognition information.

Then, after the portable communication apparatus 100 stores the information identification ID and the designated detailed information by using the transmission/reception information storage means 202, the portable communication apparatus 100 manages the respective information ID and detailed information by way of the information identification ID management means 105 and the detailed information management means 103 so as to establish a synchronization with the server 200.

Also, in such a case that there is a large amount of information, the information cannot be completely notified within 1 time. As a consequence, it is so assumed that a certain amount of the above-described information may be received in a divisional manner, and occasional information may be set.

After the portable communication apparatus 100 could acquire the detailed information designated by the lump information identification acquiring information and all of information as to the information identification IDs for identifying these designated detailed information from the server 200, the portable communication apparatus 100 receives a lump information identification acquiring response from the server 200 (step S403). This lump information identification acquiring response implies that the acquisition of the information is completed.

Then, the portable communication apparatus 100 executes an information setting operation as to both the detailed information designated by the lump information identification acquiring information and all of the information as to the information identification IDs for identifying these designated detailed information, which are received from the server 200 (step S404).

It should also be understood that the lump information acquiring response can select plural pieces of the stored detailed information. However, as to an information amount stored in the portable communication apparatus 100, a total number of information which can be stored thereinto is limited based upon a memory storage capacity of an information region. As a consequence, while the information amount may be set, the information region of the memory is variable depending upon a utilization purpose of the owner.

In FIG. 5, first of all, in the portable communication apparatus 100, the detailed information management means 103 sets and edits the detailed information so as to be stored in the server 200 under control of the apparatus operation means 107 (step S501).

The portable communication apparatus 100 notifies an information identification ID having no meaning, the detailed information, and the information setting information to the server 200 by using the apparatus transmission/reception means 101 (step S502). In this case, the above-explained information identification ID having no meaning corresponds to such an information identification ID with respect to detailed information which has not yet been registered in the server 200, but is newly registered in this server 200, and this information identification ID clearly indicates that the own information identification ID has not yet been applied to the detailed information. In order to express “having no meaning” in the drawing, a symbol “none” is described subsequent to the information identification ID.

After the server 200 has completed to register the detailed information received from the portable communication apparatus 100 into the transmission/reception information storage means 202, the server 200 resends the information identification ID of the detailed information which is requested to be set to the portable communication apparatus 100 as an information setting response by employing the server transmission/reception means 201 (step S503). The portable communication apparatus 100 sets the information identification ID by way of the information identification ID management means 105 and the detailed information management means 103 under control of the apparatus operation means 107 so as to be synchronized with the server 200 (step S504).

In FIG. 6, first of all, the portable communication apparatus 100 notifies information identification ID and information acquiring information to the server 200 by employing the apparatus transmission/reception means 101 (step S601).

The server 200 transmits an information acquiring response to the portable communication apparatus 100 (step S602). The information acquiring response is constituted by such detailed information registered in the server 200, for example, an information identification ID, a name, a mail address, and the like.

As a result, since the owner of the portable communication apparatus 100 displays the detailed information and the like, which are received from the server 200 by employing the information display means 104 of the portable communication apparatus 100 (step S603), the owner can confirm the information which has been stored in the server 200.

Since the detailed information is not basically stored in the portable communication apparatus 100, the flow chart of FIG. 6 corresponds to such a flow chart which is employed in the case that the detailed information stored in the server 200 is wanted to be confirmed.

It should also be noted that the detailed information and the like, which are displayed by employing the information display means 104, may be alternatively edited.

In FIG. 7, in the case that a change is made in information, first of all, the portable communication apparatus 100 notifies information identification ID and information acquiring information to the server 200 by employing the apparatus transmission/reception means 101 (step S701).

Then, the server 200 transmits an information acquiring response to the portable communication apparatus 100 (step S702). The information acquiring response is constituted by such detailed information registered in the server 200, for example, information identification ID, a name, a mail address, and the like.

The owner of the portable communication apparatus 100 displays the detailed information and the like, which are received from the server 200 by employing the information display means 104 of the portable communication apparatus 100, and then, the owner confirms that information which has been stored in the server 200 (step S703).

The portable communication apparatus 100 performs a content changing/editing operation of the detailed information by the detailed information management means 103 under control of the apparatus operation means 107 (step S704).

Then, the portable communication apparatus 100 notifies information identification ID of detailed information which should be changed, and the detailed information as information setting notification (step S705).

The server 200 changes the detailed information based upon the information setting notification received from the portable communication apparatus 100, and when changing of the detailed information is accomplished, the server 200 resends such an information identification ID of the detailed information which is requested to be set to the portable communication apparatus (step S706).

The portable communication apparatus 100 sets the information identification ID so as to be synchronized with the server 200 (step S707).

In FIG. 8, when the detailed information and the like are wanted to be deleted which have been stored in the server 200, the portable communication apparatus 100 notifies information deleting notification and information identification ID to the server 200 (step S801). In this case, the above-described information deleting notification is to designate the detailed information and the like, which have been stored in the server 200. The above-explained information identification ID is such an information identification ID which corresponds to information which should be deleted.

When the server 200 receives both the information deleting notification and the information identification ID corresponding thereto from the portable communication apparatus 100, this server 200 deletes the designated information which has been stored in the transmission/reception storage means 202 under control of the information setting means 204.

In such a case that the deletion of the designated information is carried out under normal operation, the server 200 resends an information deleting response and an information identification ID to the portable communication apparatus 100 by employing the server transmission/reception means 201 (step S802). At this time, the information deleting response which is transmitted to the portable communication apparatus 100 corresponds to notification information for notifying that the deleting operation of the predetermined information requested from the portable communication apparatus 100 is accomplished in the server 200. Then, the above-explained information identification ID is such an information identification ID which corresponds to the deleted information.

In the case that the portable communication apparatus 100 owns the same information which is the information deleted in the server 200, the information stored in the portable communication apparatus 100 is also deleted under control of the apparatus operation means 107 so as to synchronize the information between the portable communication apparatus 100 and the server 200 (step S803).

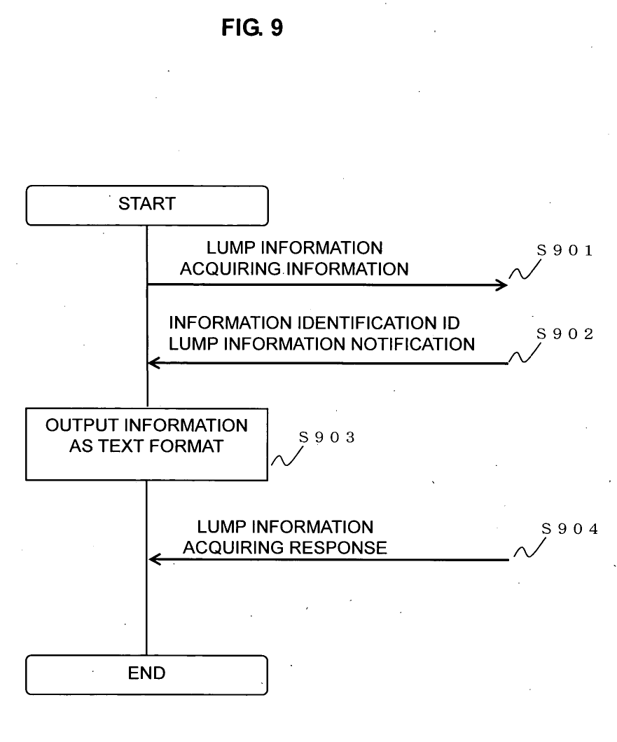

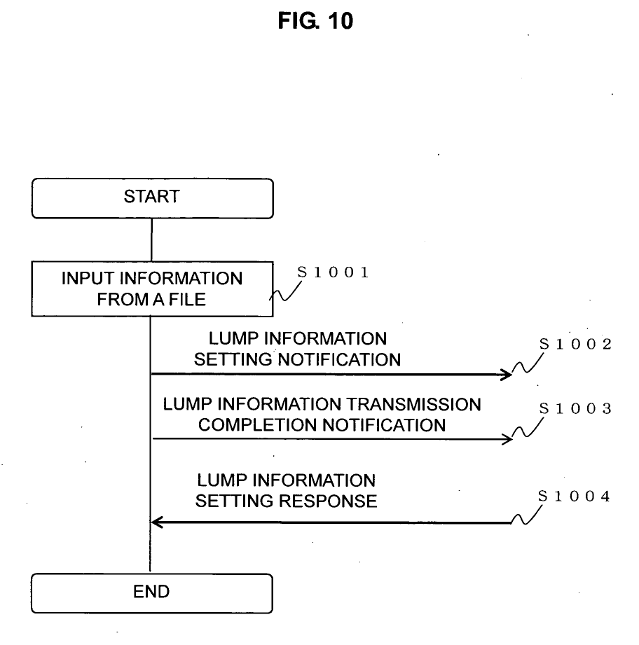

Next, a description is made of process operations for processing information of the portable communication apparatus 100 according to the embodiment of the present invention in a batch manner with reference to sequence diagrams. FIG. 9 is a sequence diagram for acquiring server storage information in a batch manner (file format of all information) in the portable communication apparatus 100. FIG. 10 is a sequence diagram for setting the server storage information (file format of all information) in the portable communication apparatus 100.

In FIG. 9, first of all, the portable communication apparatus 100 notifies lump information acquiring information to the server 200 by employing the apparatus transmission/reception means 101 (step S901).

Then, after the server 200 receives the lump information acquiring information from the portable communication apparatus 100 by the apparatus transmission/reception means 101, the server 200 notifies all of the detailed information stored in the transmission/reception information storage means 202 of the server 200, the information identification IDs corresponding thereto, and lump information notification to the portable communication apparatus 100 by employing the server transmission/reception means 201 (step S902).

Then, the portable communication apparatus 100 file-outputs the detailed information and the like as a text format, which are notified from the server 200 in the batch manner without setting the information of the portable communication apparatus 100 (step S903).

In such a case that an amount of information received from the server 200 is large and thus the information cannot be received within 1 time in the apparatus transmission/reception means 101, it is so assumed that the information communication apparatus 100 receives a portion of the information in a divisional manner, and forms occasional output information as a text format.

Also, in the portable communication apparatus 100, a file outputted in the text format may be edited by employing a tool such as an editor.

When the server 200 accomplishes to transmit all of the information, the portable communication apparatus 100 receives a lump information acquiring response from the server 200, which implies that the transmissions of all of the information are completed (step S904).

In this case, timing at which the detailed information and the like received from the server 200 are formed as the file in the text format may be alternatively defined after the lump information acquiring response has been received from the server 200.

Moreover, the format for converting the detailed information is not limited only to the text format, but may be realized by such a format that other editing tools may be used, or by an editing impossible format, or by a partially editable format. In addition, a format where security is established may be alternatively employed as the format for converting the detailed information.

In FIG. 10, first of all, the portable communication apparatus 100 inputs information from a file (step S1001), and notifies lump information setting notification to the server 200 by employing the apparatus transmission/reception means 101 (step S1002). Then, the portable communication apparatus 100 also notifies file format information with respect to the server 200 in the flow operations of FIG. 9, while the file format information has been changed by employing such a tool as an editor.

It should also be noted that as the above-described editor, an editor provided in the portable communication apparatus 100 may be employed. Alternatively, information stored in a storage medium may be edited by an editor of another electronic appliance such as a personal computer.

When the portable communication apparatus 100 transmits the lump information setting notification to the server 200 by employing the apparatus transmission/reception means 101, in such a case that an amount of information transmitted to the server 200 is large and all of the information cannot be transmitted within 1 time by the apparatus transmission/reception means 101, the portable communication apparatus 100 divides the information so as to transmit the divided portion of the information, forms occasional output information as a text format, and then transmits the lump information setting notification.

After the portable communication apparatus 100 has accomplished to transmit all of the file format information by employing the apparatus transmission/reception means 101, the portable communication apparatus 100 transmits lump information transmission completion notification to the server 200 by employing the apparatus transmission/reception means 101 (step S1003). The above-described lump information transmission completion notification notifies that the transmission is completed.

Then, the portable communication apparatus 100 receives completion notification as a lump information setting response from the server 200 (step S1004).

In the case that such a notification that setting of the lump information is abnormal is issued, the content is again confirmed, and the abnormal portion is corrected, and thereafter, the lump information may be again registered.

Also, since only setting of the lump information to the server 200 is carried out, the portable communication apparatus 100 is synchronized with the server 200 based upon the lump information identification acquiring information shown in FIG. 4. As to the synchronization timing with respect to the server 200, after the lump information has been set, the portable communication apparatus 100 may be synchronized with the server 200 based upon the lump information acquiring information.

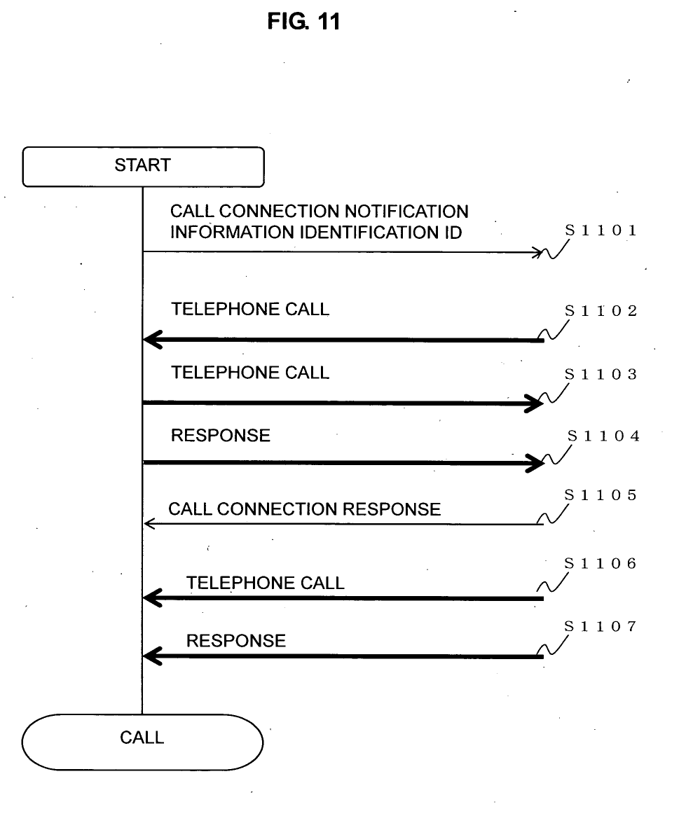

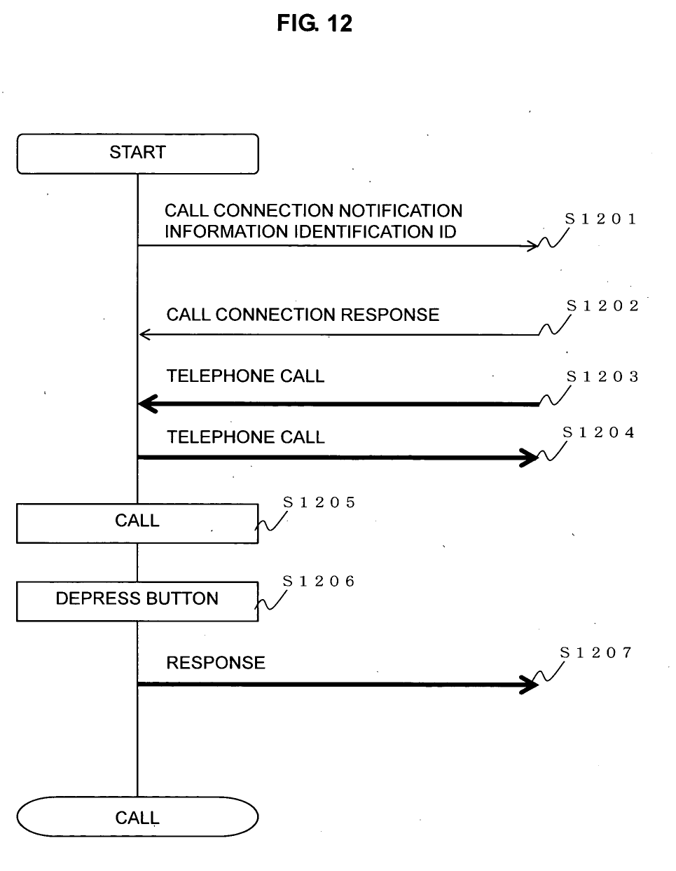

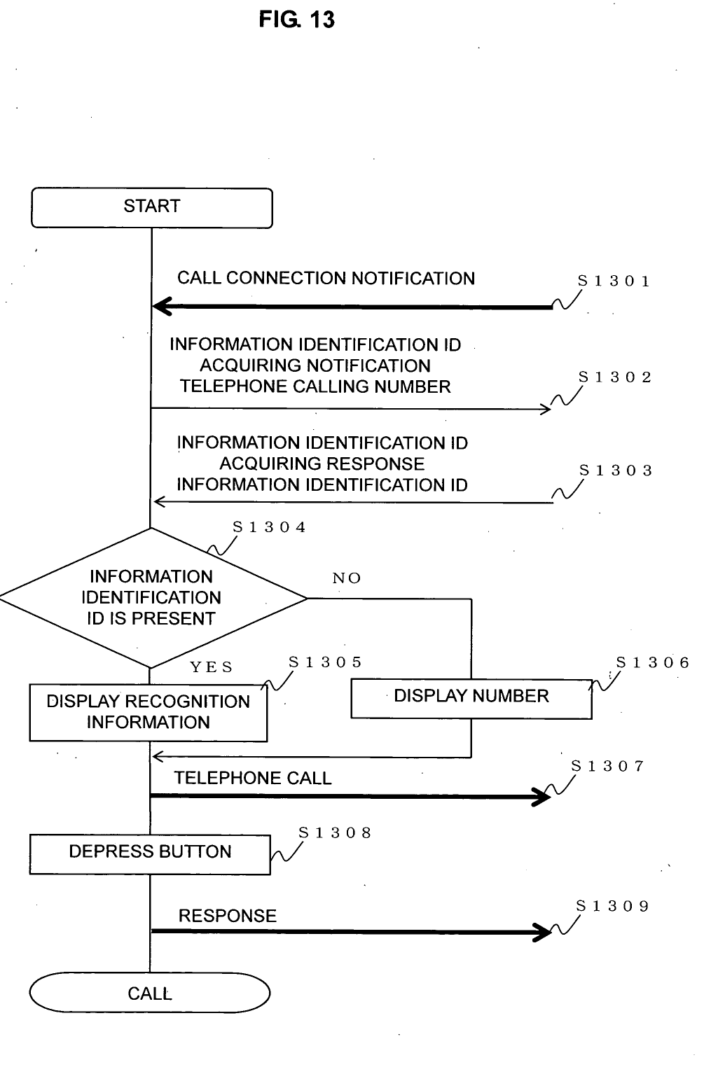

Next, a description is made of process operations for telephone communications by the portable communication apparatus 100 according to the embodiment of the present invention with reference to sequence diagrams. FIG. 11 is a sequence diagram for executing call connecting process operations (call connection/telephone calling simultaneous type process operations, namely, call connections approximated to existing call connections) executed in the portable communication apparatus 100. FIG. 12 is a sequence diagram for executing call connecting process operations (call connections/telephone calling separate type process operations) executed in the portable communication apparatus 100. FIG. 13 is a sequence diagram for describing received call connecting process operations executed in the portable communication apparatus 100.

In FIG. 11, the portable communication apparatus 100 notifies call connection notification and information identification ID to the server 200 by employing the apparatus transmission/reception means 101 (step S1101). Thereafter, the portable communication apparatus 100 receives a telephone call from the switching apparatus 306 of the transmission path system (step S1102), and resends the telephone call as a response to the switching apparatus 306 of the transmission path system (step S1103).

Since the portable communication apparatus 100 resends the response to the server 200 (step S1104), a telephone communication path is connected. Then, the server 200 resends a call connection response with respect to the response from the portable communication apparatus 100 (step S1105). Furthermore, the portable communication apparatus 100 receives the telephone call and the response from the server 200 (steps S1106 and S1107). The owner of the portable communication apparatuses 100 may have the same feeling as the existing sequence as to a series of these process operations, assuming now that there is no action made by the owner of the portable communication apparatus 100. Then, if a telephone call counter party makes a telephone answer, then the owner of the portable communication apparatus 100 can communicate with this telephone call counter party.

It should also be noted that since a telephone call and a telephone answer subsequent to the call connection response are issued by reactions made by the telephone call counter party, and connecting process operations thereof are equal to the existing connection sequence, explanations thereof are omitted.

In FIG. 12, the portable communication apparatus 100 notifies call connection notification to the server 200 in combination with information identification ID (step S1201).

When the server 200 receives the call connection notification from the portable communication apparatus 100 by using the server transmission/reception means 201, the server 200 resends a call connection response to the portable communication apparatus 100 (step S1202).

Thereafter, a telephone call is notified from the switching apparatus 306 of the transmission path system to the portable communication apparatus 100 (step S1203), and then, the portable communication apparatus 100 resends the telephone call (step S1204). In this case, the portable communication apparatus 100 is brought into such a telephone calling condition that the portable communication apparatus 100 waits for a response made by an action of a user in response to a calling sound (step S1205).

Also, in this case, the waiting condition for the response made by the action need not be a calling sound setting condition, but may be realized by, for instance, a so-called “manner mode”, or a mode equivalent to this manner mode used in another portable telephone.

Since the user depresses a telephone communication button mounted on the portable communication apparatus 100 (step S1206), a telephone communication path is connected. At this time, if the telephone call counter party has not yet made a response with respect to the connection of the telephone communication path, then the user can hear sound for indicating “telephone calling” from the receiver. When the telephone call counter party makes a response, the portable communication apparatus 100 is operated under telephone conversation (step S1207). Also, if the telephone call counter party has already made the response, then the portable communication apparatus 100 is immediately brought into the telephone conversation.

It should be understood that when there is no information identification ID corresponding to the server side, “no information” is notified as a call connection response.

In FIG. 13, when a telephone call is received from a telephone calling counter party, the portable communication apparatus 100 receives a call connection notification from the switching apparatus 306 of the transmission path system by employing the apparatus transmission/reception means 101 (step S1301).

The portable communication apparatus 100 notifies information identification ID acquiring notification to the server 200 in combination with a telephone number in order to specify the telephone calling number contained in this notification information by way of a key information identification ID (step S1302).

Then, the portable communication apparatus 100 receives both an information identification ID acquiring response and information identification ID from the server 200 by employing the apparatus transmission/reception means 101 (step S1303).

The portable communication apparatus 100 compares the information identification ID received from the server 200 with such an information identification ID Which has been previously owned and is managed by the information identification ID management means 105 (step S1304). In such a case that the coincident information identification ID is present in the portable communication apparatus 100, recognition information corresponding thereto is displayed by using the information display means 104 in the portable communication apparatus 100 (step S1305).

Also, the portable communication apparatus 100 compares the information identification ID received from the server 200 with such an information identification ID which has been previously owned and is managed by the information identification ID management means 105 (step S1304). In such a case that the coincident information identification ID is not present in the portable communication apparatus 100, the portable communication apparatus 100 judges that a telephone call is issued from a person who is not registered, and then, a telephone number is displayed in the portable communication apparatus 100 by employing the information display means 104 (step S1306).

The portable communication apparatus 100 produces a telephone calling sound so as to notify the telephone call to the switching apparatus 306 of the transmission path system (step S1307), and thereafter, since the telephone communication button is depressed (step S1308), the portable communication apparatus 100 notifies a response (step S1309), and then, is brought into telephone communication condition.

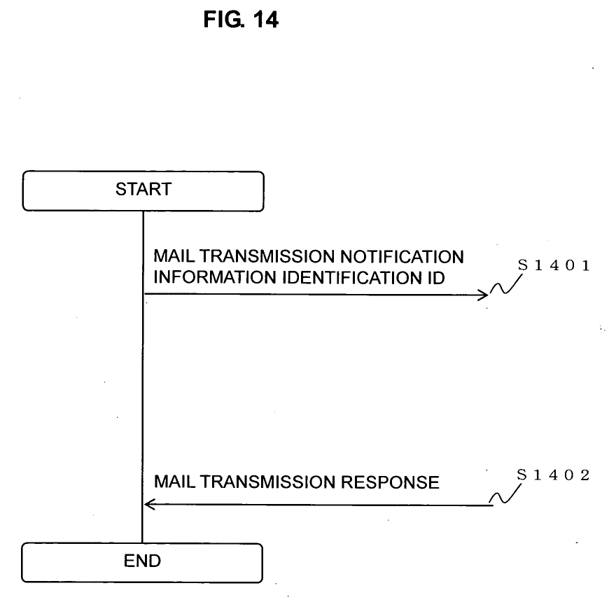

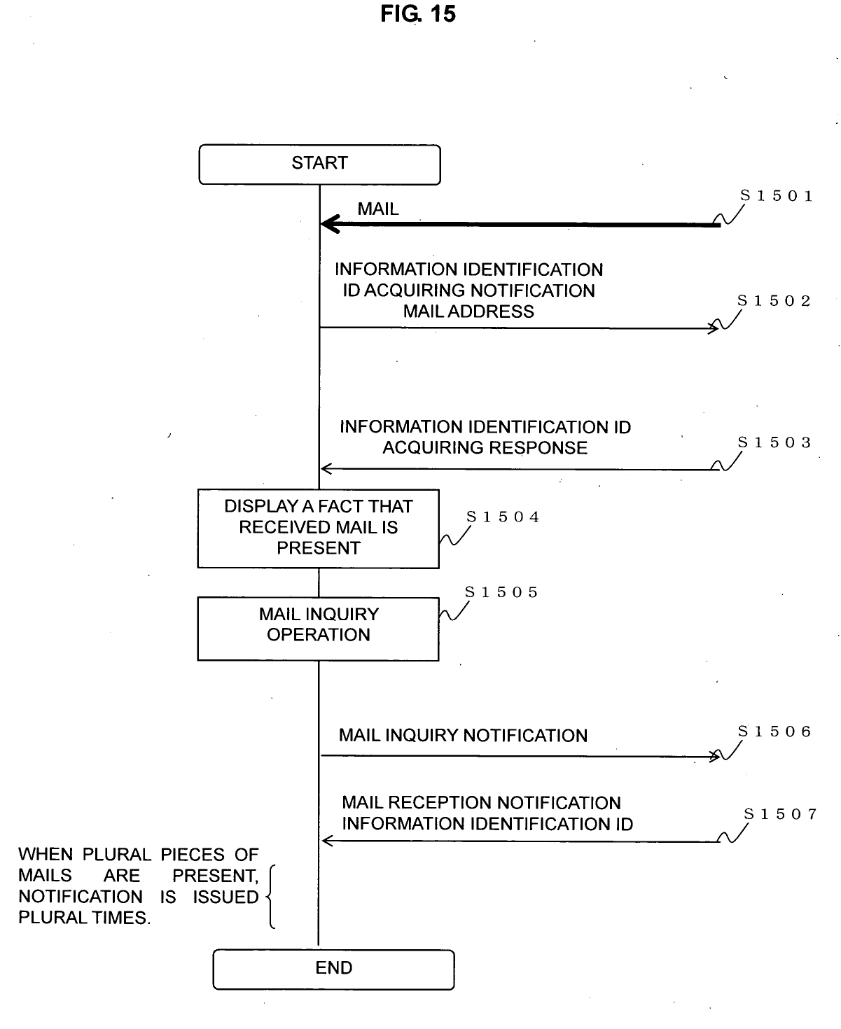

Referring now to sequence diagrams, a description is made of mail transmission processing operations executed in the portable communication apparatus 100 according to the embodiment of the present invention. FIG. 14 is a sequence diagram for explaining mail transmission process operations executed in the portable communication apparatus 100. FIG. 15 is a sequence diagram for explaining mail reception process operations executed in the portable communication apparatus 100.

In FIG. 14, the portable communication apparatus 100 notifies a mail transmission notification to the server 200 in combination with an information identification ID by employing the apparatus transmission/reception means 101 (step S1401).

Then, after the portable communication apparatus 100 has transmitted a mail to the side of the server 200, the portable communication apparatus 100 receives a mail transmission response from the server 200 (step S1402). In this case, it is so assumed that a transmission result has been applied to the mail transmission response which is transmitted by the server 200 to the portable communication apparatus 100.

When the portable communication apparatus 100 notifies the mail transmission notification, in such a case that the corresponding information identification ID is not present on the side of the server 200, “no information” is notified as the mail transmission response.

In FIG. 15, when the portable communication apparatus 100 receives a mail from the switching apparatus 306 of the transmission path system (step S1501), the portable communication apparatus 100 notifies information identification ID acquiring notification to the server 200 in combination with a mail address (step S1502).

Then, the information identification ID is notified as an information identification ID acquiring response from the server 200 to the portable communication apparatus 100 (step S1503), and such a fact that the received mail is present is displayed on the portable communication apparatus 100 by employing the information display means 104 (step S1504).

When the owner of the portable communication apparatus 100 performs a mail inquiry operation (step S1505), mail inquiry notification is notified to the server 200 (step S1506), and mail reception notification is notified in combination with an information identification ID (step S1507).

It should also be noted that when plural pieces of mails are present, the notification is issued from the server 200 to the portable communication apparatus 100 plural times.

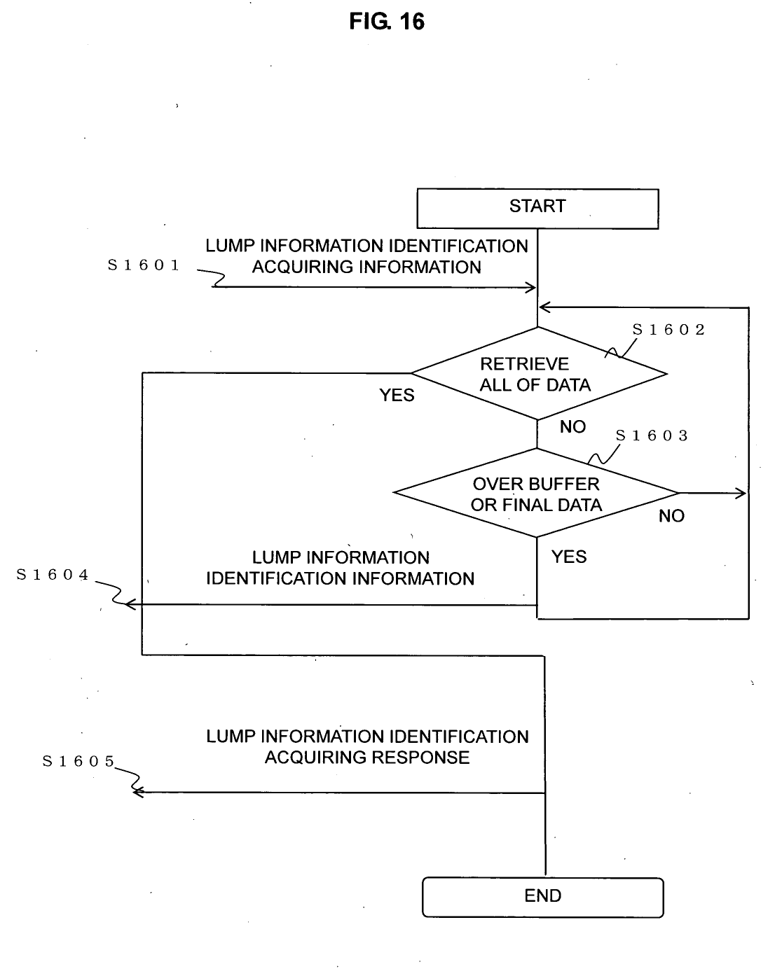

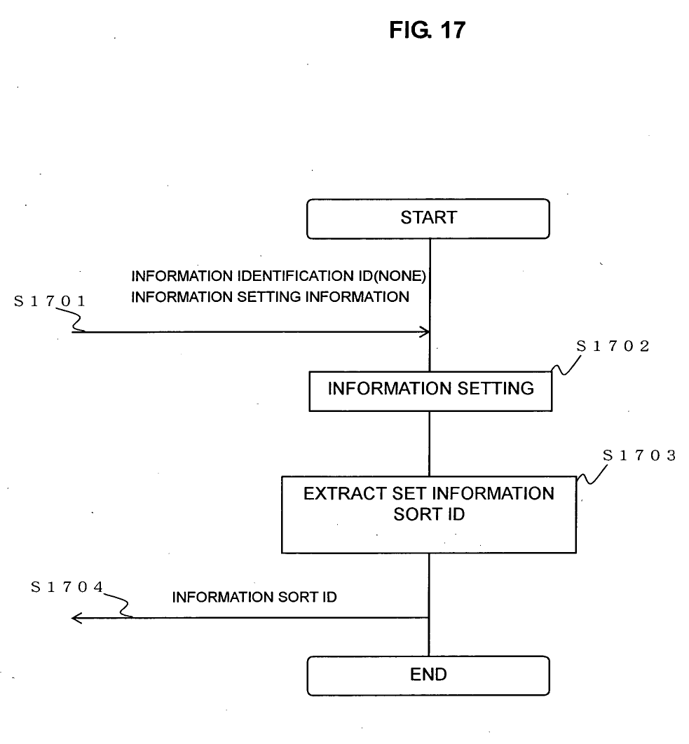

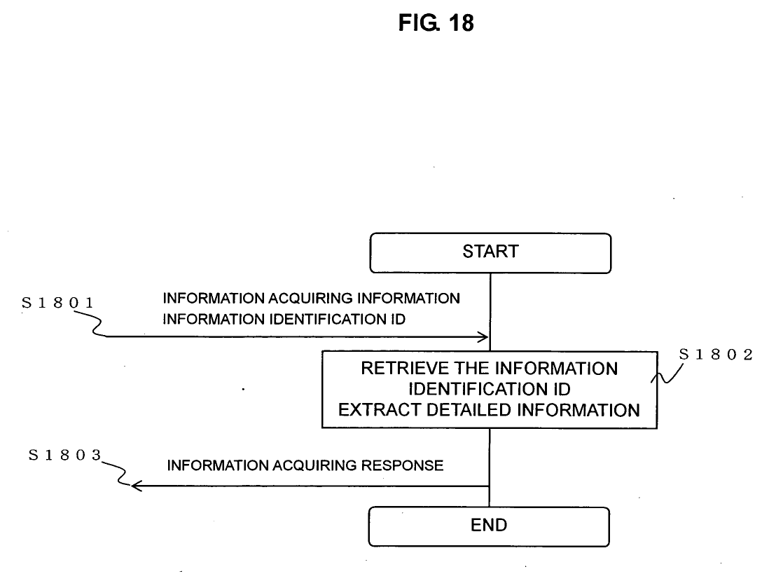

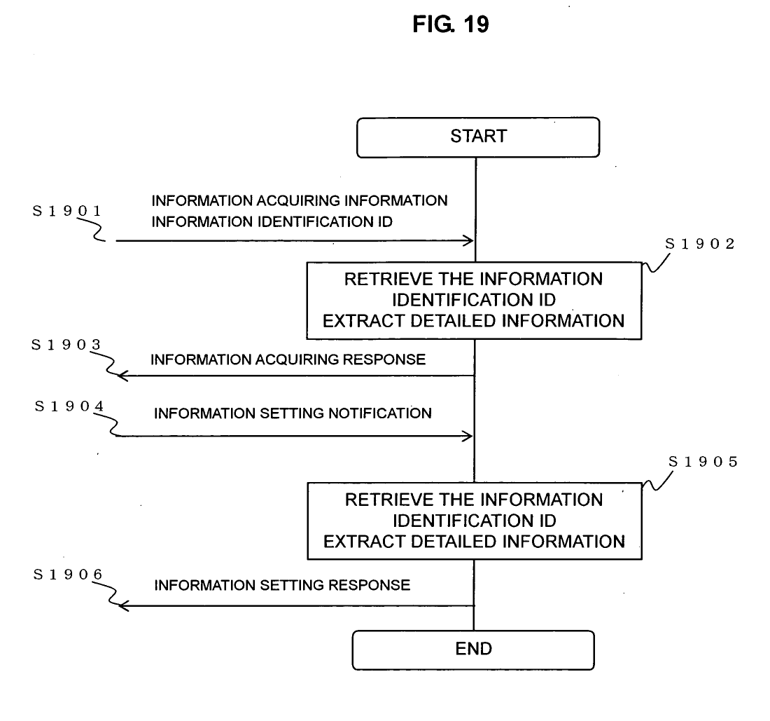

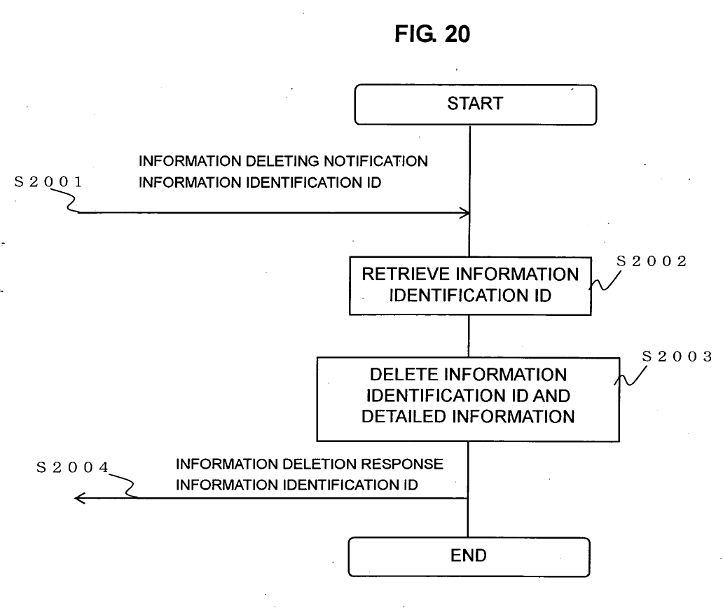

Next, information manipulation processing operations executed by the server 200 in the embodiment of the present invention will now be described with reference to sequence diagrams. FIG. 16 is a sequence diagram for indicating an information acquiring request (acquisition of information identification ID and recognition information) issued from the portable communication apparatus 100 in the server 200. FIG. 17 is a sequence diagram for representing process operations executed when server storage information is acquired (acquisition of information identification ID and recognition information) in the portable communication apparatus 100. FIG. 18 is a sequence diagram for requesting to acquire detailed information from the portable communication apparatus 100 performed in the server 200. FIG. 19 is a sequence diagram for requesting to set new information from the portable communication apparatus 100 performed in the server 200. FIG. 20 is a sequence diagram for requesting to delete information from the portable communication apparatus 100 performed in the server 200.

In FIG. 16, when the server 200 receives lump information identification acquiring information from the portable communication apparatus 100 by employing the server transmission/reception means 201 (step S1601), the server 200 retrieves all of the data managed in the own server 200 by using the information retrieving means 205 (step S1602), and then, notifies lump information identification with respect to the portable communication apparatus 100 (step S1604). In this case, the above-explained lump information identification information is constructed of an information identification ID and recognition information. The above-explained recognition information corresponds to such an information for designating respective detailed information, for example, names, telephone numbers mail addresses as to friends and fellow workers of the owner of the portable communication apparatus 100.

Then, since there is a limitation in a transmission amount of information which can be transmitted by the server 200 to the portable communication apparatus 100, the server 200 checks a transmission buffer amount in a predetermined interval (step S1603). When the buffer amount becomes zero, the server 200 transmits information buffered in a transmission buffer (not shown) to the portable communication apparatus 100 (step S1604). Thereafter, the following process operation is repeatedly carried out. That is, information which is subsequently transmitted is stored in the transmission buffer, the server 200 checks a transmission buffer amount, and when the buffer amount becomes zero, the server 200 transmits information to the portable communication apparatus 100. After the notification of all of the information which have been stored in the buffer is accomplished, the server 200 resends a lump information identification acquiring response to the portable communication apparatus 100 by employing the server transmission/reception means 201 (step S1605).

It should also be understood that the lump information identification acquiring response can select plural pieces of the stored detailed information. However, as to an information amount stored in the portable communication apparatus 100, a total number of information which can be stored thereinto is limited based upon a memory storage capacity of an information region. As a consequence, while the information amount may be set, the information region of the memory is variable depending upon a utilization purpose of the owner.

It should also be noted that although the transmission buffer is not illustrated in the block diagram of the server of FIG. 2, the transmission buffer may be provided in, for example, the server transmission/reception means 201, or may be alternatively constituted as a separate hardware structure with respect to the server transmission/reception means 201.

In FIG. 17, the server 200 receives both an information identification ID having no meaning and information setting information from the portable communication apparatus 100 by employing the server transmission/reception means 201 (step S1701). In this case, the above-explained information identification ID having no meaning corresponds to such an information identification ID with respect to detailed information which has not yet been registered in the server 200, but is newly registered in this server 200, and this information identification ID clearly indicates that the own information identification ID has not yet been applied to the detailed information. In order to express “having no meaning” in the drawing, a symbol “none” is described subsequent to the information identification ID.

Then, the server 200 stores detailed information as newly added information into the transmission/reception information storage means 202, and after the server 200 sets information by employing the information setting means 204, the server 200 allocates an information sort ID with respect to each of the detailed information (step S1702).

The server 200 extracts the set information sort ID as an information setting response for the portable communication apparatus 100 (step S1703), and then, resends the extracted information sort ID to the portable communication apparatus 100 by using the server transmission/reception means 201 (step S1704).

In FIG. 18, the server 200 receives both the information acquiring information and the information identification ID from the portable communication apparatus 100 by employing the server transmission/reception means 201 (step S1801).

Then, the server 200 retrieves the information identification ID from the information stored in the transmission/reception storage means 202 so as to extract detailed information of such an information identification ID which is coincident with the information identification ID received from the portable communication apparatus 100 (step S1802), and then, the server 200 resends this extracted detailed information as an information acquiring response to the portable communication apparatus 100 by using the server transmission/reception means 201 (step S1803). The information acquiring response is constituted by such detailed information registered in the server 200, for example, an information identification ID, a name, a mail address, and the like.

As a result, since the owner of the portable communication apparatus 100 displays the detailed information and the like, which are received from the server 200 by employing the information display means 104 of the portable communication apparatus 100, the owner can confirm the information which has been stored in the server 200.

In FIG. 19, similar to FIG. 18, first of all, the server 200 receives both the information acquiring information and the information identification ID from the portable communication apparatus 100 by employing the server transmission/reception means 201 (step S1901).

Then, the server 200 retrieves the information identification ID from the information stored in the transmission/reception storage means 202 so as to extract detailed information of such an information identification ID which is coincident with the information identification ID received from the portable communication apparatus 100 (step S1902), and then, the server 200 resends this extracted detailed information as an information acquiring response to the portable communication apparatus 100 by using the server transmission/reception means 201 (step S1903). The information acquiring response is constituted by such detailed information registered in the server 200, for example, an information identification ID, a name, a mail address, and the like.

As a result, since the owner of the portable communication apparatus 100 displays the detailed information and the like, which are received from the server 200 by employing the information display means 104 of the portable communication apparatus 100, the owner can confirm the information which has been stored in the server 200.

The portable communication apparatus 100 changes a content of detailed information by using the detailed information management means 103 under control of the apparatus operation means 107. Then, the portable communication apparatus 100 notifies both an information identification ID of such a detailed information which should be changed, and the detailed information as information setting notification (step S1904).

Then, after the server 200 has received the information setting notification from the portable communication apparatus 100 by employing the server transmission/reception means 201, the server 200 retrieves the information identification ID from the information stored in the transmission/reception information storage 202 by employing the information retrieving means 205, and sets the detailed information of the information identification ID which is coincident with the information identification ID received form the portable communication apparatus 100 (concretely speaking, sever 200 performs overwrite setting operation) in a step S1905. Then, the server 200 resends the information identification ID of the detailed information which is requested to be set to the portable communication apparatus (step S1906).

Also, the portable communication apparatus 100 sets the information identification ID so as to be synchronized with the server 200.

In FIG. 20, the server 200 receives both an information deleting notification and an information identification ID from the portable communication apparatus 100 (step S2001). In this case, the above-explained information deleting notification is to designate detailed information and the like, which have been stored in the server 200. Furthermore, the above-described information identification ID implies such an information identification ID corresponding to information which should be deleted.

Then, the server 200 retrieves the information identification ID from the information stored in the transmission/reception information storage means 202 by employing the information retrieving means 205 (step S2002), and deletes both the information identification ID and the detailed information of the information identification ID which is coincident with the information identification ID received from the portable communication apparatus 100 under control of the information setting means 204 (step S2003).

Then, in such a case that the information deleting operation is carried out under normal operation, the server 200 transmits both an information deletion response and an information identification ID to the portable communication apparatus 100 by employing the server transmission/reception means 201 (step S2004).

At this time, the information deletion response transmitted to the portable communication apparatus 100 corresponds to such a notification information for notifying that the deleting operation of the predetermined information requested from the portable communication apparatus 100 is completed in the server 200. Then, the above-explained information identification ID implies such an information identification ID which corresponds to the deleted information.

In the case that the portable communication apparatus 100 owns such an information which is identical to the information deleted in the server 200, the portable communication apparatus 100 also deletes the information stored in the own portable communication apparatus 100 under the control of the apparatus operation means 107 so as to synchronize the information between the portable communication apparatus 100 and the server 200.

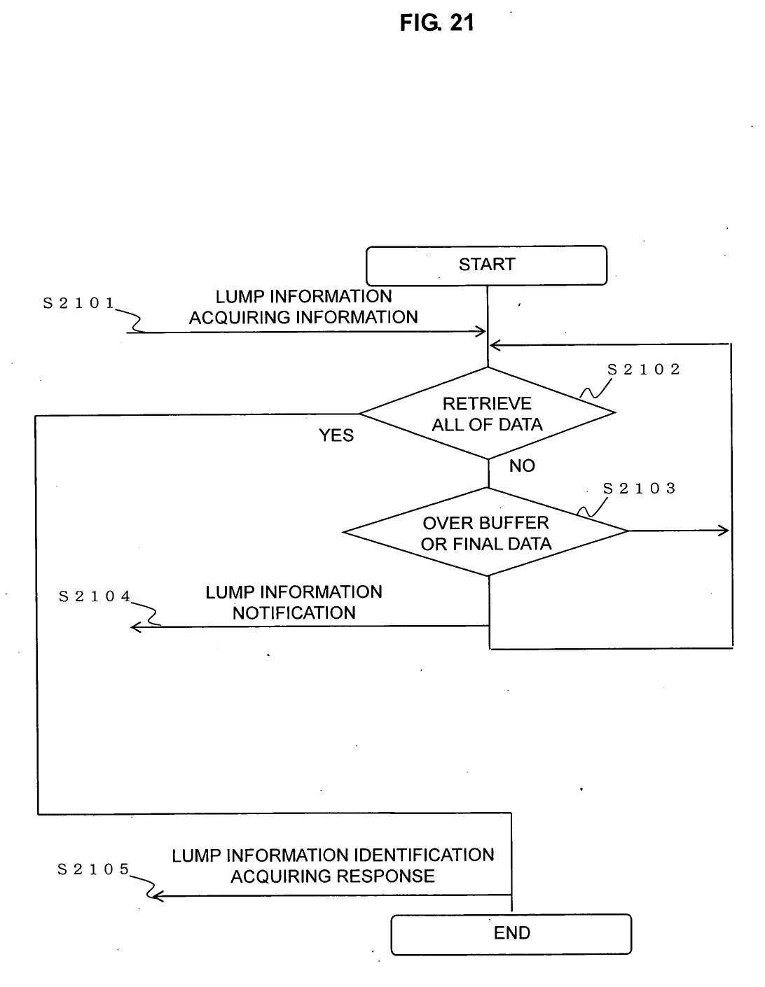

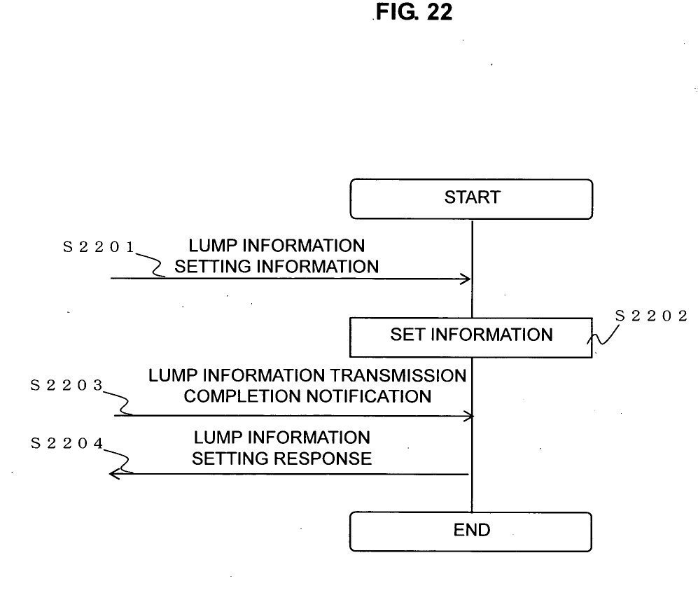

Next, a description is made of process operations for processing information in a batch mode in the server 200 in the embodiment of the present invention with reference to sequence diagrams. FIG. 21 is a sequence diagram for requesting to acquire information in a batch mode (all information file format) from the portable communication apparatus performed in the server 200. FIG. 22 is a sequence diagram for requesting to set information in a batch mode (all information file format) from the portable communication apparatus performed in the server 200.

In FIG. 21,, when the server 200 receives lump information acquiring information from the portable communication apparatus 100 by employing the server transmission/reception means 201 (step S2101), the server 200 retrieves all of the data managed in the own server 200 by using the information retrieving means 205 (step S2102), and then, notifies all of the detailed information which have been stored in the transmission/reception information storage means 202 of the server 200, the information identification IDs corresponding thereto, and lump information notification to the portable communication apparatus 100 by using the apparatus transmission/reception means 101 (step S2104).

Then, since there is a limitation in a transmission amount of information which can be transmitted by the server 200 to the portable communication apparatus 100, the server 200 checks a transmission buffer amount in a predetermined interval (step S2103). When the buffer amount becomes zero, the server 200 transmits information buffered in a transmission buffer (not shown) to the portable communication apparatus 100 (step S2104). Thereafter, the following process operation is repeatedly carried out. That is, information which is subsequently transmitted is stored in the transmission buffer, the server 200 checks a transmission buffer amount, and when the buffer amount becomes zero, the server 200 transmits information to the portable communication apparatus 100. After the notification of all of the information which have been stored in the buffer is accomplished, the server 200 resends a lump information identification acquiring response to the portable communication apparatus 100 by employing the server transmission/reception means 201 (step S2105).

It should also be understood that the lump information acquiring response can select plural pieces of the stored detailed information. However, as to an information amount stored in the portable communication apparatus 100, a total number of information which can be stored thereinto is limited based upon a memory storage capacity of an information region. As a consequence, while the information amount may be set, the information region of the memory is variable depending upon a utilization purpose of the owner.

It should also be noted that although the transmission buffer is not illustrated in the block diagram of the server of FIG. 2, the transmission buffer may be provided in, for example, the server transmission/reception means 201, or may be alternatively constituted as a separate hardware structure with respect to the server transmission/reception means 201.

In FIG. 22, the server 200 receives lump information setting information from the portable communication apparatus 100 by employing the server transmission/reception means 201 (step S2201). Now, in such a case that an amount of information which is received by the server 200 from the portable communication apparatus 100 is large and therefore this information cannot be received within 1 time by the server transmission/reception means 201, the server 200 receives a divided information portion of the information in a divisional manner, and receives lump information setting notification (step S2201).

The server 200 matches notified detailed information of a file format with respect to all of the data managed by the server 200, and then, sets and deletes difference information (step S2202).

Then, when the server 200 receives lump information transmission completion notification sent from the portable communication apparatus 100 (step S2203), the matching process operation is ended. The server 200 resends a lump information setting response to the portable communication apparatus 100 (step S2204).

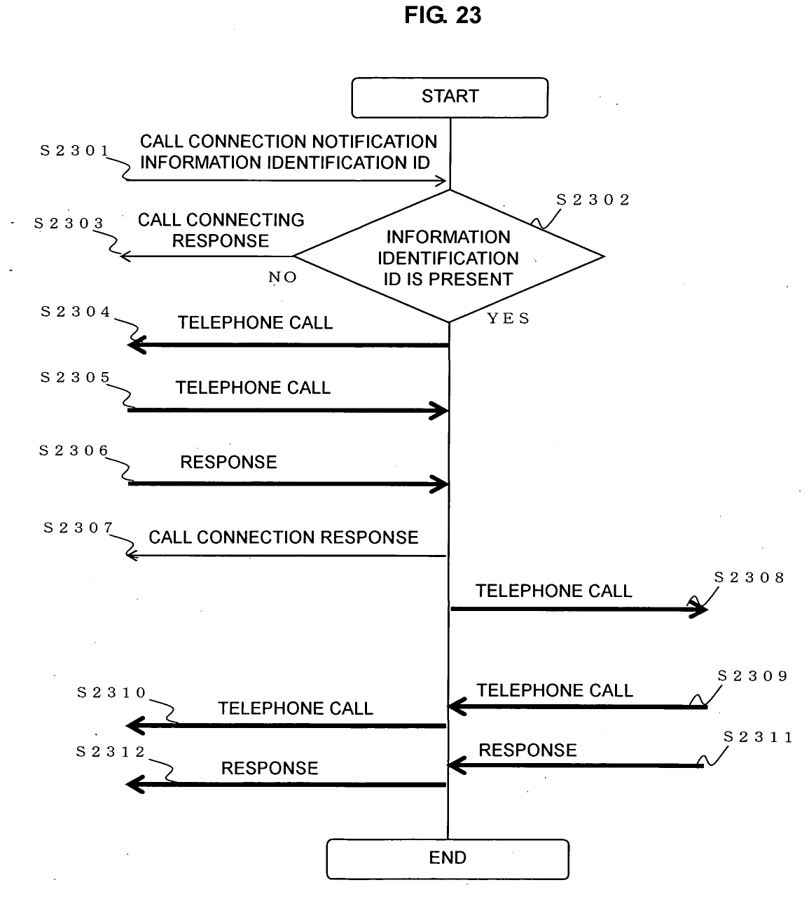

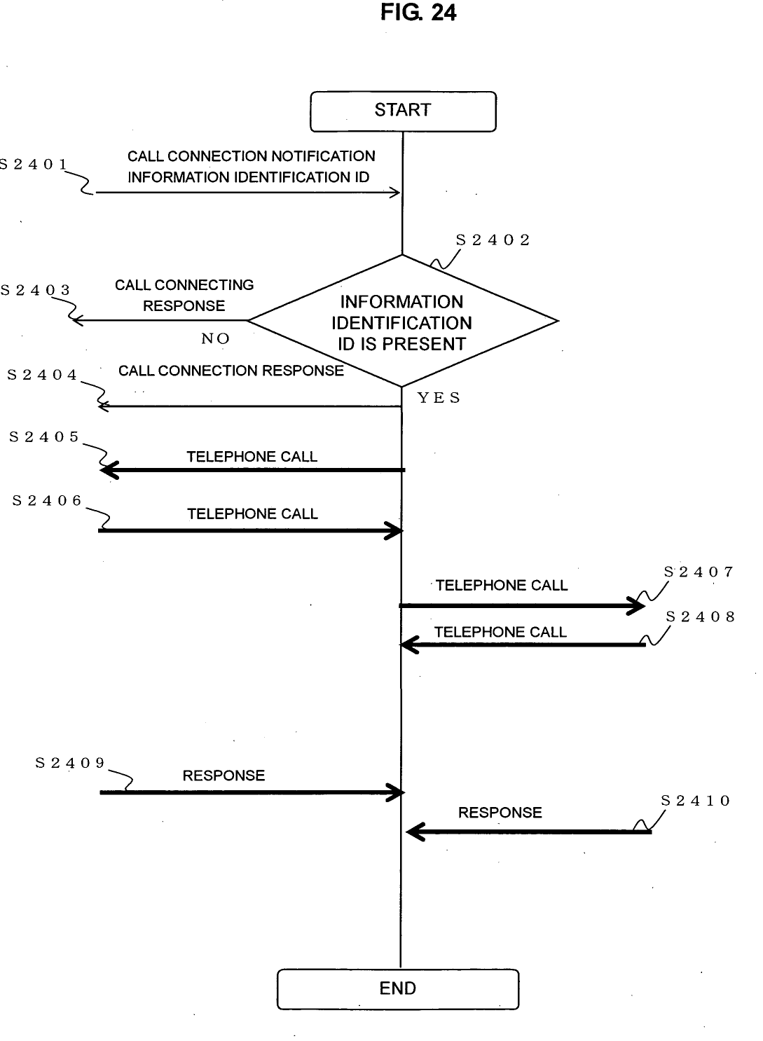

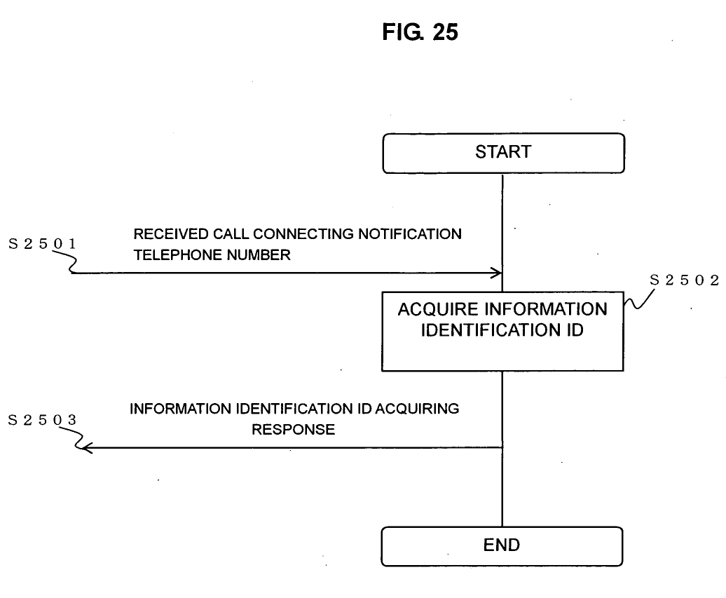

Next, a description is made of process operations for telephone communications by the server 200 according to the embodiment of the present invention with reference to sequence diagrams. FIG. 23 is a sequence diagram for executing call connecting process operations (call connection/telephone calling simultaneous type process operations, namely, call connections approximated to existing call connections) executed in the server 200. FIG. 24 is a sequence diagram for executing call connecting process operations (call connections/telephone calling separate type process operations) executed in the server 200. FIG. 25 is a sequence diagram for describing received call connecting process operations executed in the server 200.

In FIG. 23, the server 200 receives call connection notification from the portable communication apparatus 100 in combination with an information identification ID by employing the server transmission/reception means 201 (step S2301).

Thereafter, the server 200 retrieves the information identification ID received from the portable communication apparatus 100 from the information identification IDs which have been stored in the transmission/reception information storage means 202 by using the information retrieving means 205 (step S2302), and then, acquires telephone number information of a telephone call received destination which corresponds to the coincident information identification ID. Also, as a result of the retrieving operation by employing the information retrieving means 205, when there is no such an information which is coincident with the received information identification ID, the server 200 sends a call connecting response as to “non-information” to the portable communication apparatus 100 by employing the server transmission/reception means 201 (step S2303).

In the case that the server 200 can extract the telephone number information of the telephone call received party, the server 200 notifies a telephone call to the switching apparatus 306 of the transmission path system in order to firstly execute a telephone communication path connecting process operation of the telephone calling side (step S2304).

Then, the server 200 is brought into such a waiting condition that this server 200 waits for telephone calling notification (step S2305) and response notification (step S2306) from the switching apparatus 306 of the transmission path system. Also, the server 200 resends a call connection response to the portable communication apparatus 100 by employing the server transmission/reception means 201 (step S2307).

The server 200 receives both the telephone call notification and the response notification from the switching apparatus 306 of the transmission path system by employing the server transmission/reception means 201, so that the telephone communication path connection on the telephone calling side is brought into a completion condition, and thus, the server 200 executes a telephone communication path connecting sequence with respect to the telephone call received party by employing a telephone number of the telephone call received party.

The server 200 transmits a telephone call to the side of the telephone call received party by employing the server transmission/reception means 201 (step S2308), and when the server 200 receives a telephone call from the telephone call received party (step S2309), the server 200 sends out a telephone call signal to the telephone calling side and is brought into the telephone calling state (step S2310).

Then, when the server 200 receives a response from the telephone call received party by using the server transmission/reception means 201 (step S2311), the server 200 transmits the response to the telephone calling side by using the server transmission/reception means 201, and is brought into a telephone communication state (step S2312).

In FIG. 24, the server 200 receives call connection notification from the portable communication apparatus 100 in combination with an information identification ID by employing the server transmission/reception means 201 (step S2401).

Thereafter, the server 200 retrieves the information identification ID received from the portable communication apparatus 100 from the information identification IDs which have been stored in the transmission/reception information storage means 202 by using the information retrieving means 205 (step S2402), and then, acquires telephone number information of a telephone call received destination which corresponds to the coincident information identification ID. Also, as a result of the retrieving operation by employing the information retrieving means 205, when there is no such an information which is coincident with the received information identification ID, the server 200 sends a call connecting response as to “non-information” to the portable communication apparatus 100 by employing the server transmission/reception means 201 (step S2403). Then, in the case that the server 200 can extract the telephone number information of the telephone call received party, the server 200 resends the call connection response to the portable communication apparatus 100, and executes such a process operation that a telephone communication path connection of the telephone calling side is performed (step S2404). Then, the server 200 sends telephone calling notification to the switching apparatus 306 of the transmission path system by employing the server transmission/reception means 201 (step S2405), and is brought into such a condition that the server 200 waits for both telephone calling notification and response notification (step S2406). Also, the server 200 sends the telephone calling notification also to the telephone call received party (step S2407), and is brought into such a condition that the server 200 waits for both telephone calling notification and response notification (step S2408). Then, the server 200 performs a telephone communication path connecting operation upon receipt of response signals issued from the telephone calling apparatus and the call receiving apparatus. When any one of the telephone calling apparatus and the call receiving apparatus is under non-connected condition, a speech message indicative of “under calling operation” is heard from a receiver with respect to such an apparatus to which the telephone communication path has been connected (step S2409). It should be understood that a telephone call receiving party is a person who receives a telephone call, and when the telephone call receiving party receives a telephone call, this party has a sense of incongruity for hearing of telephone calling sound. Taking account of this incongruity sense, a speech message different from the telephone calling sound may be alternatively heard. When the responses are issued from both the telephone calling apparatus and the call receiving apparatus (step S2410), a telephone communication path is connected between both the telephone calling/receiving apparatus, so that these telephone calling/receiving apparatus are under telephone communication condition. At this time, such a response for clearly indicating operation transition from “telephone calling” to “under telephone communication” may be notified to such an apparatus which has firstly issued the response.

In FIG. 25, when the server 200 receives a telephone call from a telephone calling party, this server 200 receives received call connecting notification from the portable communication apparatus 100 in combination with a telephone number by employing the server transmission/reception means 201 (step S2501).

Then, the server 200 retrieves the telephone number received from the portable communication apparatus 100 from the telephone numbers stored in the transmission/reception information storage means 202 by employing the information retrieving means 205, and acquires an information identification ID which corresponds to the coincident telephone number (step S2502).

The server 200 resends the acquired information identification ID as an information identification ID acquiring response to the portable communication apparatus 100 by employing the server transmission/reception means 201 (step S2503).

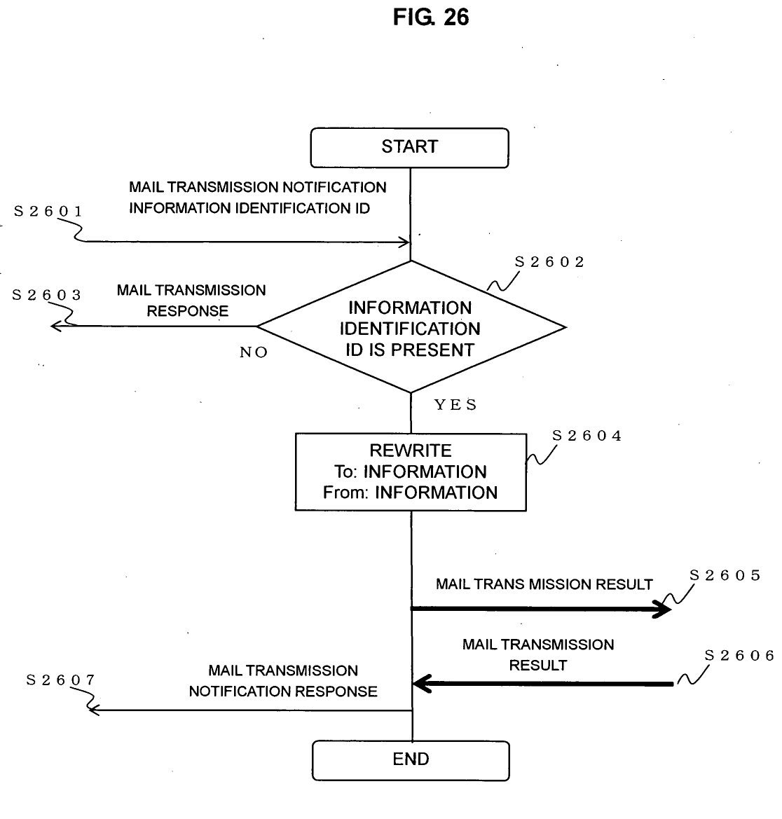

Next, a description is made of process operations for transmitting/receiving mails executed by the server 200 in the embodiment of the present invention with reference to sequence diagrams. FIG. 26 is a sequence diagram for explaining a mail transmission processing operation executed in the server 200.

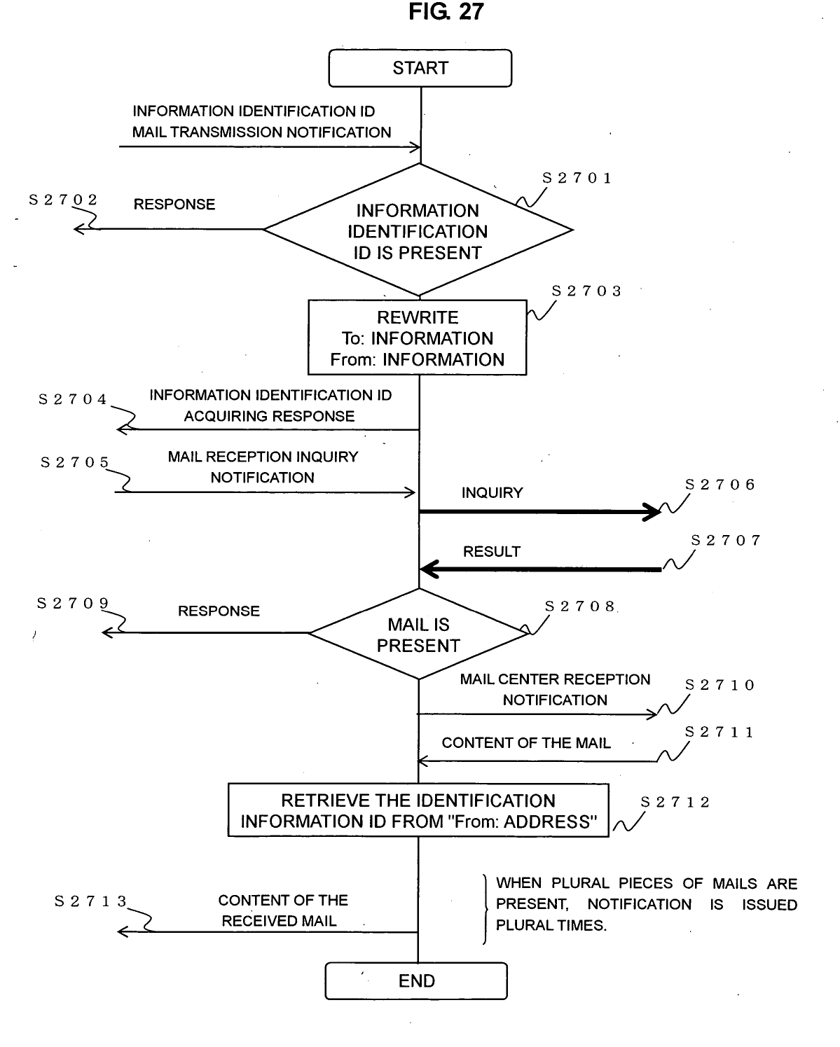

FIG. 27 is a sequence diagram for explaining a mail reception processing operation executed in the server 200.

In FIG. 26, the server 200 receives mail transmission notification from the portable communication apparatus 100 in combination with an information identification ID by employing the server transmission/reception means 201 (step S2601).

Then, the server 200 retrieves the information identification ID received from the portable communication apparatus 100 from the information identification IDs stored in the transmission/reception storage means 202 by employing the information retrieve means 205 (step S2602) so as to acquire a mail address of a mail transmission destination. Also, as a result of retrieving the received information identification ID by using the information retrieve means 205, in the case that there is no such an information which is coincident with the received information identification ID, the server 200 sends a mail transmission response of “no information” to the portable communication apparatus 100 by employing the server transmission/reception means 201 (step S2603).

Then, if the server 200 can acquire the mail address of the mail transmission destination, then the server 200 rewrites “To: information” by the transmission destination mail address by employing the information setting means 204, and also, rewrites “From: information” by an address of a mail sender (namely, mail address of person who manages server information) by employing the information setting means 204, and then, transmits the mail by using the server transmission/reception means 201 (step S2604).

Then, the server 200 transmits the transmission result as a mail transmission response by employing the server transmission/reception means 201 to the portable communication apparatus 100 (step S2605), receives a mail transmission result (step S2606), and also, notifies a mail transmission notification response to the portable communication apparatus 100 by employing the server transmission/reception means 201 (step S2607).

In FIG. 27, the server 200 receives mail transmission notification from the portable communication apparatus 100 in combination with an information identification ID by employing the server transmission/reception means 201.

Then, the server 200 retrieves the information identification ID received from the portable communication apparatus 100 from the information identification IDs stored in the transmission/reception storage means 202 by employing the information retrieve means 205 (step S2701) so as to acquire a mail address of a mail transmission destination. Also, as a result of retrieving the received information identification ID by using the information retrieve means 205, in the case that there is no such an information which is coincident with the received information identification ID, the server 200 sends a response of “no information” to the portable communication apparatus 100 by employing the server transmission/reception means 201 (step S2702).

Then, if the server 200 can acquire the mail address of the mail transmission destination, then the server 200 rewrites “To: information” by the transmission destination mail address by employing the information setting means 204, and also, rewrites “From: information” by an address of a mail sender (namely, mail address of person who manages server information) by employing the information setting means 204, and then, transmits an information identification ID acquiring response by using the server transmission/reception means 201 (step S2704).

The server 200 receives mail reception inquiry notification sent from the portable communication apparatus 100 by using the server transmission/reception means 201 (step S2705).

Then, the server 200 issues an inquiry with respect to a mail center (step S2706). As a result (step S2707), the server 200 judges as to whether or not a mail is present (step S2708). When reception information is not present, the server 200 issues a response of “no reception mail” by using the server transmission/reception means 201 (step S2709). Also, in the case that the mail is received from the portable communication apparatus 100, the server 200 retrieves the identification information ID from “From: address” by employing the information retrieving means 205, and responds the identification information ID as a mail reception inquiry response by the server transmission/reception means 201.

When the server 200 receives mail reception notification from the portable communication apparatus 100 by employing the server transmission/reception means 201, the server 200 issues mail center reception notification (step S2710).

The server 200 receives the content of the mail from the mail center (step S2711), and retrieves the identification information ID from “From: address” of the mail content by using the information retrieving means 205 (step S2712), and then, notifies the content of the received mail with the identification ID to the portable communication apparatus 100 (step S2713).

The above-described sequences are merely one example for embodying the present invention. Therefore, even when the orders of the respective steps represented in the sequences are replaced with each other, if similar effects may be achieved, then these relevant steps may be alternatively replaced with each other.

Since the above-explained arrangements and operations of the present invention are employed, while the portable communication apparatus is cooperated with the server, the server manages the information, and the server takes the initiative based upon this information, so that such a service as a call connection service and a mail transmission service can be received.

Also, modifications and other technical extendable items as to the above-described embodiment modes of the portable communication apparatus will now be described in the blow-mentioned items:

(1). In the above-explained embodiment mode, the portable telephone has been exemplified as the portable communication apparatus. However, the portable communication apparatus of the present invention is not limited only to this portable telephone, but may be realized by any of information processing apparatus if these information processing apparatus are communicatable with the server.

(2). Although all of the data have been converted into the data having the file format and the format-converted data have been controlled in the above-explained embodiment, the present invention is not limited only thereto. Alternatively, the data may be controlled without being converted into the data having the file format. Also, only partial data of these data may be alternatively converted into the data having the file format.

What is claimed is:

1. An information processing apparatus capable of communicating with an information managing apparatus capable of managing stored information stored in the information processing apparatus, the information processing apparatus comprising:
a storage unit for storing an identification information identifying predetermined information from said stored information so as to extract said identification information from said information managing apparatus;
an identification information managing unit for editing said identification information stored in said storage unit for managing the identification information; and
an information transmitting/receiving unit for instructing an acquisition of said stored information in order that information managed in said identification information managing unit is transmitted to said information managing apparatus, and transmitting/receiving said identification information and said stored information with respect to said information managing apparatus.

2. An information processing apparatus according to claim 1, further comprising:
a transmission/reception information capacity determining unit for determining as to whether or not both said identification information and said stored information can be transmitted/received within 1 time, and
an information dividing unit for dividing both said identification information and said stored information in the case that said transmission/reception information capacity determining unit determines that both said identification information and said stored information cannot be transmitted/received within 1 time.

3. An information processing apparatus according to claim 2, wherein:
said information transmission/reception unit transmits both said identification information and said stored information in a divisional manner.

4. An information processing apparatus according to claim 2, wherein:
said information dividing unit divides both said identification information and said stored information by such a size that said divided information can be transmitted by said information transmission/reception unit.

5. An information processing apparatus according to claim 2, further comprising:
an information restoring unit for restoring the divided identification information and the divided stored information in the case that both said identification information and said stored information have been divided.

6. An information processing apparatus according to claim 1, further comprising:
a converting unit for converting both said stored information and said identification information into a file format.

7. An information managing apparatus capable of communicating with an information processing apparatus and capable of managing stored information stored in the information processing apparatus, the information managing apparatus comprising:
an information storage unit for storing said stored information;
an information managing unit managing based upon identification information identifying predetermined information from said stored information so as to extract said identification information from said information managing apparatus;
an identification retrieving unit capable of retrieving both said stored information and said identification information;
an identification information setting unit for editing/setting the identification information retrieved by said information retrieving unit; and
an information transmitting/receiving unit for transmitting/receiving both said identification information and said stored information with respect to said information processing apparatus.

8. An information managing apparatus according to claim 7, further comprising:
a transmission/reception information capacity determining unit for determining as to whether or not both said identification information and said stored information can be transmitted/received within 1 time; and
an information dividing unit for dividing both said identification information and said stored information in the case that said transmission/reception information capacity determining unit determines that both said identification information and said stored information cannot be transmitted/received within 1 time.

9. An information managing apparatus according to claim 7, wherein:
said information transmission/reception unit is also capable of transmitting/receiving a signal with respect to a switching apparatus of a transmission path system.

10. An information storing method capable of communicating information stored in an information processing apparatus with respect to an information managing apparatus capable of managing said stored information, the information storing method comprising the steps of:
storing identification information identifying predetermined information from said stored information so as to extract said identification information from said information managing apparatus;
editing said identification information so as to manage the identification information; and
instructing an acquisition of said stored information in order that information managed is transmitted to said information managing apparatus, and
transmitting/receiving said identification information and said stored information with respect to said information managing apparatus.

11. An information storing program capable of communicating information stored in an information processing apparatus with respect to an information managing apparatus capable of managing said stored information, executed by programmed processor, the information storing program comprising the steps of:
storing identification information identifying predetermined information from said stored information so as to extract said identification information from said information managing apparatus;
editing said identification information so as to manage the identification information; and
instructing an acquisition of said stored information in order that information managed is transmitted to said information managing apparatus, and
transmitting/receiving said identification information and said stored information with respect to said information managing apparatus.
